(19) United States
(12) Patent Application Publication
(10) Pub. No.: US 2019/0174206 A1
(43) Pub. Date: Jun. 6, 2019

(54) LIGHT LAUNCH DEVICE WITH IMPROVED USABILITY AND PERFORMANCE

(71) Applicant: CORNING RESEARCH & DEVELOPMENT CORPORATION, Corning, NY (US)

(72) Inventors: Rami Anolik, Beit Arie (IL); Lior Assif, Petah Tikva (IL); Pinhas Yehuda Rosenfelder, Beit-Shemesh (IL); Carmi Shapiro, D.N. Modiin (IL); Refael Torika, Rosh Haayin (IL); Dayne Wilcox, El Cerrito, CA (US)

(21) Appl. No.: 16/108,743

(22) Filed: Aug. 22, 2018

Related U.S. Application Data
(60) Provisional application No. 62/594,843, filed on Dec. 5, 2017.

(51) Int. Cl. H04Q 1/02; H01R 13/66

(52) U.S. Cl. CPC H04Q 1/136; H01R 13/6683

(57) ABSTRACT

Disclosed herein is a light launch device with improved usability and performance. In particular, the light launch device includes an internally housed launch cable and emission connector, a removable faceplate, alternating laser emission, and/or optimized pulse emission. The internally housed launch cable and emission connector facilitate portability and ease of use by consolidating the various components of the light launch device. The removable faceplate is positioned over the bulkhead connected to the input connector of a launch cable assembly to prevent access to the connection during normal use but selectively allowing access for maintenance or launch cable assembly replacement. The alternating laser emissions and/or optimized pulse emission decreases power consumption and/or maintains or improves cable tracing effectiveness.

### CROSS REFERENCE TO RELATED APPLICATION

This application claims the benefit of priority of U.S. Provisional Application Ser. No. 62/594,843, filed Dec. 5, 2017, the content of which is relied upon and incorporated herein by reference in its entirety.

### BACKGROUND

The disclosure relates to a light launch device with improved usability and performance. In particular, the disclosure relates to a light launch device with at least some internally housed cable, at least one optical connector, a removable faceplate, alternating laser emission, and/or optimized cycle emission range.

Computer networks continue to increase in size and complexity. Businesses and individuals rely on these networks to store, transmit, and receive critical data at high speeds. Even with the expansion of wireless technology, wired connections remain critical to the operation of computer networks, including enterprise data centers. Portions of these wired computer networks are regularly subject to removal, replacement, upgrade, or other moves and changes. To ensure the continued proper operation of each network, the maze of cables connecting the individual components must be precisely understood and properly connected between specific ports.

In many cases, a network's cables, often called patch cords, can be required to bridge several meters across a data center, among other uses (e.g., within high performance computers, in outside-plant cabinets, etc.). These cables are often used between racks of servers, switches, and patch panels. The cables may begin in one equipment rack, run through the floor or other conduit, and terminate at a component in a second equipment rack. Data center operators may need to reconfigure patch panel endpoints to adapt to changes in use patterns or to turnover in equipment, which requires knowing the attachment location of both ends of the cable. To change the configuration of a patch cord, an operator needs to know where both ends of the cord are attached. However, in practice, it is not unusual for the operators to only know where one end of the patch cord is connected. Determining the location of the other end of a particular cable can be time consuming and fraught with risk. For example, disconnecting the wrong cable can interrupt important or critical network traffic.

FIGS. 1A-1B are views of network cables (e.g., patch cords 100) used in fiber optic equipment. More specifically, FIG. 1A is a perspective view of an equipment rack 102 supporting patch cords 100, and FIG. 1B is a perspective view of an under-floor cable tray 104 supporting patch cords 100. FIGS. 1A-1B illustrate a problem that occurs in data centers or similar network locations, which is congestion and clutter caused by large quantities of patch cords 100. Network operators frequently need to change connections to accommodate moves, additions, and changes in the network. However, operators may find it difficult to trace a particular patch cord 100 from the source to the receiver (e.g., ends of the patch cords 100) when the network location is congested, as illustrated in FIGS. 1A and 1B.

As a result, there is a need for a traceable cable and/or light launch device that allows a network operator to quickly identify the terminal end of a given cable (e.g., such as those that are being replaced, relocated, or tested) with a low possible risk of error.

No admission is made that any reference cited herein constitutes prior art. Applicant expressly reserves the right to challenge the accuracy and pertinency of any cited documents.

### SUMMARY

Disclosed herein is a light launch device that may be used with a traceable patchcord to help identify the ends of the patchcord. The light launch device has improved usability and performance. In particular, the light launch device includes a launch cable and emission connector, a removable faceplate, alternating laser emission, and/or optimized pulse emission. The internally housed launch cable and emission connector facilitate portability and ease of use by consolidating the various components of the light launch device. The removable faceplate is positioned over the bulkhead connected to the input connector of a launch cable assembly to prevent access to the connection during normal use but selectively allowing access for maintenance or launch cable assembly replacement. The alternating laser emissions and/or optimized pulse emissions decrease power consumption while maintaining, or in some cases improving, cable tracing effectiveness.

One embodiment of the disclosure relates to a light launch device for a traceable fiber optic cable assembly. The light launch device includes a housing, at least one light source, and a launch cable assembly. The housing includes a body and a cover. The body and the cover define an interior of the housing therebetween. The light source is configured for generating an optical tracing signal. The launch cable assembly includes an emission connector and a launch cable. The emission connector is positionable within the interior of the housing. The launch cable includes a first launch optical fiber. The first launch optical fiber includes a first input end and a first emission end. The first emission end is in the emission connector and the first input end is in optical communication with the light source to receive the optical tracing signal therefrom. The launch cable is positionable within the interior of the housing.

An additional embodiment of the disclosure relates to a light launch device for a traceable fiber optic cable assembly. The light launch device includes a housing, at least one light source, and a launch cable assembly. The housing includes a body with a bulkhead and a faceplate removably attached to the body and covering the bulkhead when attached to the body. The at least one light source for generating an optical tracing signal is within the body and in communication with an optical connector receptacle on the bulkhead. The launch cable assembly includes a launch cable, an input connector at a first end of the launch cable, and an emission connector at a second end of the launch cable. The input connector is coupled to the optical connector receptacle of the bulkhead and the emission connector is configured to selectively engage a fiber optic connector of a traceable fiber optic cable.

An additional embodiment of the disclosure relates to a light launch device for a traceable fiber optic cable assembly. The light launch device includes a housing, at least one light source, and a launch cable assembly. The at least one light source is positioned within the housing for generating a first optical tracing signal and a second optical tracing signal. The launch cable assembly includes an input connector, an emission connector, a first launch optical fiber, and a second launch optical fiber. The input connector is configured to receive the first and second optical tracing signals from the light source. The emission connector is configured to selectively engage a fiber optic connector of a traceable fiber optic cable. The first launch optical fiber includes a first input end and a first emission end. The first input end is in communication with the light source to receive the first optical tracing signal therefrom, and the first emission end is in the emission connector. The second launch optical fiber includes a second input end and a second emission end. The second input end is in communication with the light source to receive the second optical tracing signal therefrom, and the second emission end is in the emission connector. The light source is configured to alternate emission of the first optical tracing signal into the first launch optical fiber and emission of the second optical tracing signal into the second launch optical fiber.

An additional embodiment of the disclosure relates to a light launch device for a traceable fiber optic cable assembly. The light launch device includes a housing, at least one light source, and a launch cable assembly. The light source is located within the housing for generating an optical tracing signal. The launch cable assembly includes an input connector, an emission connector, and a first launch optical fiber. The input connector is configured to receive the first and second optical tracing signals from the light source. The emission connector is configured to selectively engage a fiber optic connector of a traceable fiber optic cable. The first launch optical fiber includes a first input end and a first emission end. The first input end is in communication with the light source to receive the first optical tracing signal therefrom, and the first emission end is in the emission connector. The light source is configured to pulse emission of the first optical tracing signal into the first launch optical fiber such that light is emitted between 25%-35% of the duration of each cycle.

Additional features and advantages will be set forth in the detailed description which follows, and in part will be readily apparent to those skilled in the art from that description or recognized by practicing the embodiments as described herein, including the detailed description which follows, the claims, as well as the accompanying drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1A is a perspective view of an equipment rack supporting patch cords;

FIG. 1B is a perspective view of an under-floor cable tray supporting patch cords;

FIG. 2A is a perspective view of a light launch device with an emission connector of a launch cable assembly of the light launch device attached to a first fiber optic connector of a data cable assembly;

FIG. 2B is a perspective view of the emission connector of the light launch device of FIG. 2A;

FIG. 3A is a schematic diagram of another embodiment of an exemplary cable tracing system;

FIG. 3B is another schematic diagram illustrating the cable tracing system of FIG. 3A;

FIG. 3C is another schematic diagram illustrating the cable tracing system of FIG. 3A;

FIG. 4 is a more detailed schematic diagram of an exemplary cable tracing system;

FIG. 5A is a top perspective view of an exemplary light launch device in a closed orientation;

FIG. 5B is a bottom perspective view of the light launch device of FIG. 5A in a closed orientation;

FIG. 6A is a top perspective view of the light launch device of 5A-5B in an open orientation and with a faceplate attached;

FIG. 6B is a perspective view of the light launch device of FIG. 6A with the faceplate removed;

FIG. 6C is a perspective back view of the faceplate of the light launch device of FIG. 6A;

FIG. 7A is a view of the light launch device of FIGS. 5A-6C with the hub plate removed;

FIG. 7B is a perspective view of internal components of the light launch device of FIG. 7A;

FIG. 8A is a perspective view of an exemplary mandrel structure of a light launch device;

FIG. 8B is a view illustrating light emission intensity from an optical fiber without use of the mandrel structure of FIG. 8A;

FIG. 8C is a view illustrating light emission intensity from an optical fiber using the mandrel structure of FIG. 8A;

FIG. 9A is a perspective view illustrating assembly of a first spool of an exemplary embodiment of a spool stack for use in a light launch device;

FIG. 9B is a perspective view illustrating assembly of a second spool of the spool stack of FIG. 9A;

FIG. 9C is a perspective view illustrating assembly of the second spool of the spool stack of FIG. 9A;

FIG. 10A is a perspective view illustrating assembly of a first spool of another exemplary embodiment of a spool stack for use in a light launch device; and

FIG. 10B is a perspective view illustrating removal of a second spool of the spool stack of FIG. 10A.

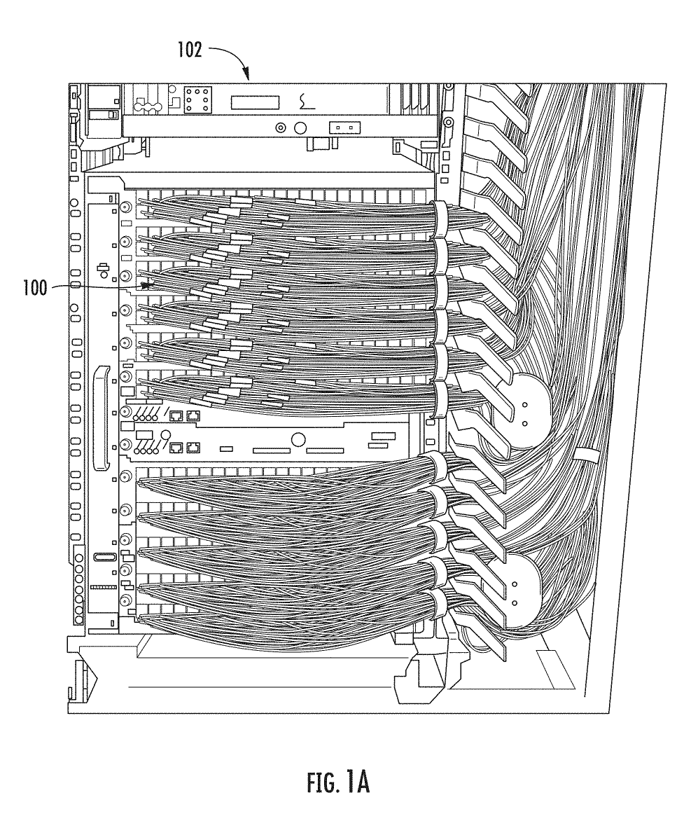

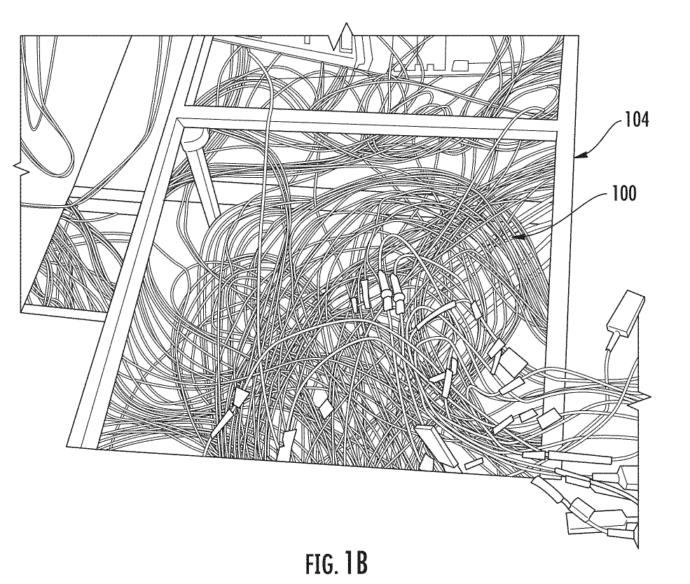

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

Terms such as “left,” “right,” “top,” “bottom,” “front,” “back,” “horizontal,” “parallel,” “perpendicular,” “vertical,” “lateral,” “coplanar,” and similar terms are used for convenience of describing the attached figures and are not intended to limit this description. For example, terms such as “left side” and “right side” are used with specific reference to the drawings as illustrated and the embodiments may be in other orientations in use. Further, as used herein, terms such as “horizontal,” “parallel,” “perpendicular,” “vertical,” etc., include slight variations that may be present in working examples.

As used herein, the terms “optical communication,” “in optical communication,” and the like mean, with respect to two or more elements, that the elements are arranged such that optical signals may be passively or actively transmittable therebetween via a medium, such as, but not limited to, an optical fiber, one or more ports, free space, index-matching material (e.g., structure or gel), reflective surfaces, connectors, or other light directing or transmitting means.

As used herein, the terms “fiber optic cables” and/or “optical fibers” include all types of single mode and multi-mode light waveguides, including one or more optical fibers that may be uncoated, coated, colored, buffered, ribbonized and/or have other organizing or protective structure in a cable or outside of a cable, such as one or more tubes, strength members, jackets or the like.

As used herein, the term “signal” refers to light transmitted between devices, and such light may be modulated with data or an unmodulated. Unmodulated light may include, for example, a continuous wave of light.

As used herein, the term “data fiber” refers to an optical fiber for propagating modulated light.

As used herein, the term “coupler” refer to a device that connects light between at least two points, and includes, by way of example, optical connectors, optical fibers, ports, free space, index-matching material (e.g., structure or gel), and reflective surfaces. A coupler need not permanently connect light between the points, and may be removable and reconnectable.

Disclosed herein is a light launch device which may be used to inject light into a traceable patchcord or other device. In particular, the light launch device includes a launch cable, an emission connector, a removable faceplate, alternating laser emission, and/or optimized pulse emission. The internally housed launch cable and emission connector facilitate portability and ease of use by consolidating the various components of the light launch device. The removable faceplate is positioned over the bulkhead connected to the input connector of a launch cable assembly to prevent access to the connection during normal use but selectively allowing access for maintenance or launch cable assembly replacement. The alternating laser emissions and/or optimized pulse emissions decrease power consumption while maintaining, or in some cases improving, cable tracing effectiveness.

The content of U.S. patent application Ser. No. 15/411,157, entitled “Traceable Fiber Optic Cable Assembly with Fiber Guide and Tracing Optical Fibers for Carrying Light Received from a Light Launch Device;” U.S. patent application Ser. No. 15/411,198, entitled “Traceable Fiber Optic Cable Assembly with Illumination Structure and Tracing Optical Fibers for Carrying Light Received from a Light Launch Device;” and U.S. patent application Ser. No. 15/411,235, entitled “Light Launch Device for Transmitting Light into a Traceable Fiber Optic Cable Assembly with Tracing Optical Fibers,” are incorporated herein by reference in their entirety.

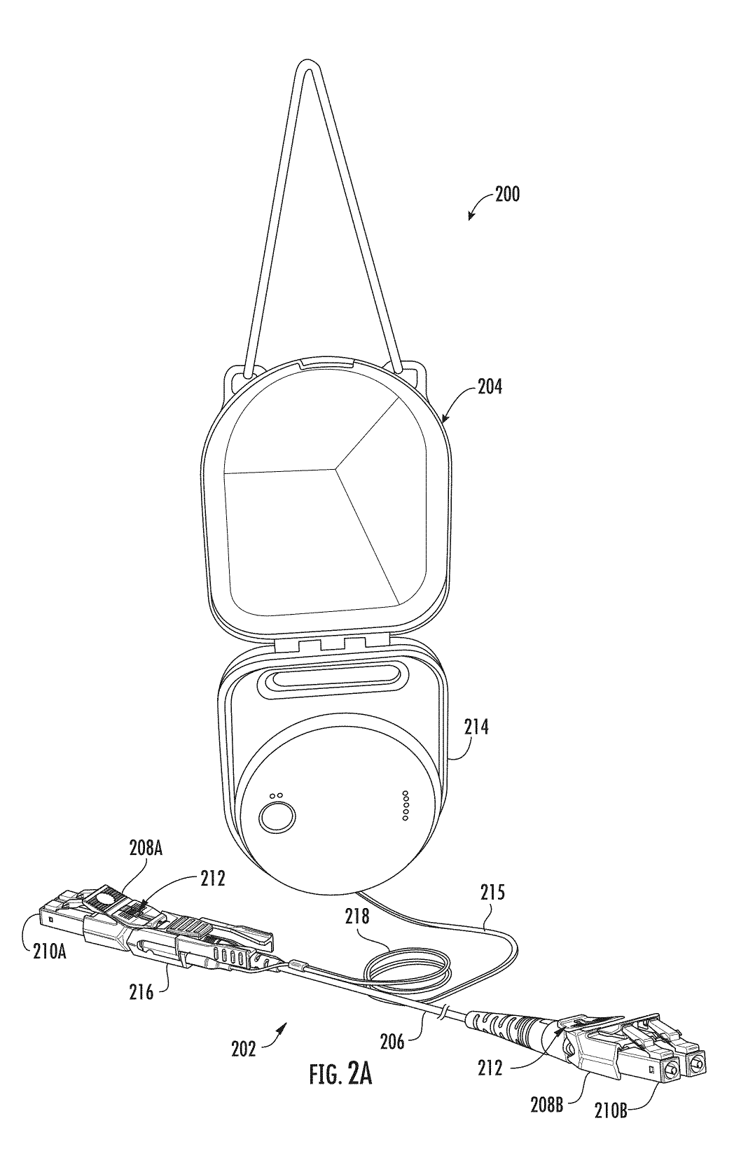

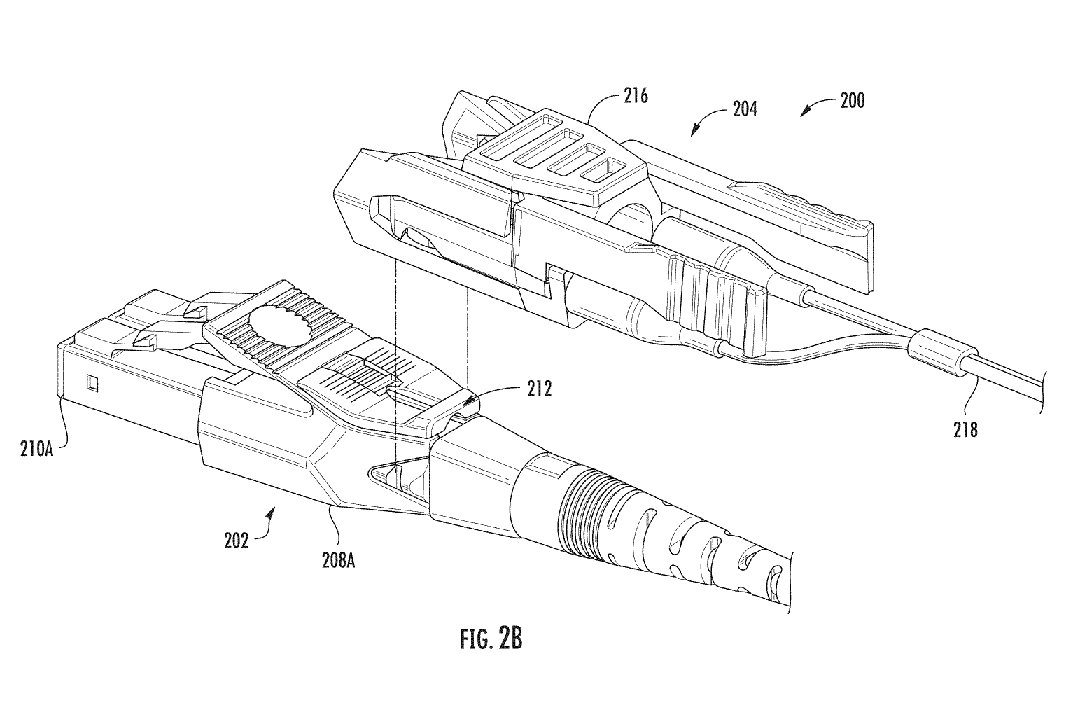

FIG. 2A illustrates an exemplary cable tracing system 200 that can be used to allow a user to identify an opposite end of a fiber optic cable assembly 202 (may also be referred to as a data cable assembly, traceable cable assembly, etc.). The process of identifying a length of cable, a portion of the length of a cable, or an end point of the cable may be referred to as “tracing” the cable. The cable tracing system 200 facilitates tracing of ends of a traceable fiber optic cable (e.g., fiber optic cable 206) using fiber optic tracing signals. FIG. 2A illustrates a light launch device 204 with an emission connector 216 of a launch cable assembly of the light launch device 204 attached to a first fiber optic connector 208A of a data cable assembly. The cable tracing system 200 comprises a traceable fiber optic cable assembly 202 and a light launch device 204 that is attachable to and removable from the traceable fiber optic cable assembly 202. The cable tracing system 200 allows a user to selectively attach the light launch device 204 to a part of the traceable fiber optic cable assembly 202 and use the light launch device 204 to inject one or more optical tracing signals (e.g., a fiber optic tracing signal, a first optical tracing signal, a second optical tracing signal, etc.) into the traceable fiber optic cable assembly 202. This allows the user to trace the location of part or all of the traceable fiber optic cable assembly 202 based on the propagation of the optical tracing signals in the traceable fiber optic cable assembly 202.

The traceable fiber optic cable assembly 202 includes a fiber optic cable 206, a first fiber optic connector 208A (may also be referred to as a traceable fiber optic cable first connector, traceable fiber optic cable assembly first connector, etc.) at a first end of the fiber optic cable 206, and a second fiber optic connector 208B (may also be referred to as a traceable fiber optic cable second connector, traceable fiber optic cable assembly second connector, etc.) at a second end of the fiber optic cable 206. The first fiber optic connector 208A and the second fiber optic connector 208B are present on opposite ends (e.g., first end 210A, and second end 210B) of the fiber optic cable 206 to allow the traceable fiber optic cable assembly 202 to act as a patch cord between components of a network. In use, the fiber optic cable 206 may extend between two locations, such as two equipment racks in a data center, telecommunications room, or the like. In some embodiments, the fiber optic cable 206 may have a length between close to zero meters and about 30 meters. In many embodiments, the fiber optic cable 206 may have a length between about 1 meter and about 5 meters. In other embodiments, the fiber optic cable 206 may have a length of more than 30 meters.

The first and second fiber optic connectors 208A, 208B are merely exemplary and other types of connectors other than the ones illustrated may be used. Thus, although FIGS. 2A-2B (among other figures herein) illustrate the first and second fiber optic connectors 208A, 208B as LC duplex connectors (e.g., Uniboot LC duplex connectors), the features described below may be applicable to different connector configurations and different connector sub-assembly designs. This includes simplex configurations of LC connector sub-assemblies, and both simplex and duplex configurations of different (i.e., non-LC) connector sub-assembly designs. In certain embodiments, the first and second fiber optic connectors 208A, 208B could include ribbon fiber or multi-fiber connectors (e.g., MPO (multi-fibre push on) connectors, MTP connectors, etc.). In some embodiments, each end of the fiber optic cable 206 includes a different type of connector, and/or, in some embodiments, the fiber optic cable 206 includes a furcation so that one or both ends of the cable include multiple cable segments and/or multiple connectors.

In certain embodiments, the first and second fiber optic connectors 208A, 208B each comprise an illumination component 212 to direct (e.g., propagate) the light emitted from a tracing fiber of the fiber optic cable 206 so that the fiber optic connectors 208A, 208B are more easily visible, for example, to workers in a data center environment. For example, in some embodiments, the illumination component 212 of the second fiber optic connector 208B illuminates after receiving a first fiber optic tracing signal from the first fiber optic connector 208A. The illumination of the second fiber optic connector 208B may communicate the location of the second fiber optic connector 208B, and/or the second illumination component 212 of the first fiber optic connector 208A, to a worker. In some embodiments, a first fiber optic tracing signal and a second fiber optic tracing signal are transmitted consecutively and/or not simultaneously (e.g., not concurrently). In this way, one or more tracing optical fibers within the fiber optic cable 206 can provide for traceability of the fiber optic cable 206 from one or both of the ends 210A, 210B of the fiber optic cable 206. The cable tracing system 200 provides the ability to trace a fiber optic cable 206 without disconnecting the fiber optic cable 206 from corresponding receptacles or ports.

In one embodiment, the traceable fiber optic cable assembly 202 comprises an end point only (EPO) configuration. In an EPO configuration, a far end of the traceable fiber optic cable assembly 202 (e.g., second fiber optic connector 208B or a portion thereof) illuminates when a near end of the traceable fiber optic cable assembly 202 (e.g., a first fiber optic connector 208A) is activated (e.g., receives an optical tracing signal). However, in other embodiments, the traceable fiber optic cable assembly 202 comprises an along-the-length (ATL) configuration. In an ATL configuration, at least a portion of the fiber optic cable 206 is illuminated. In some ATL configurations, the first fiber optic connector 208A (or a portion thereof) and/or the second fiber optic connector 208B (or a portion thereof) may also be illuminated in addition to a portion of the fiber optic cable 206. In certain embodiments, in an ATL configuration light is emitted continuously along a length of the fiber optic cable 206 or at multiple points long a length of the fiber optic cable 206. While the description below is written with respect to an EPO configuration, the teachings are also applicable to an ATL configuration.

The light launch device 204 comprises a launch module 214 and a launch cable assembly 215 including an emission connector 216 and a launch cable 218 positioned between the launch module 214 and the emission connector 216. The launch module 214 generates the fiber optic tracing signal for direction through the launch cable 218 to the emission connector 216.

The emission connector 216 is selectively attachable to and removable from a traceable fiber optic cable assembly (e.g., the traceable fiber optic cable assembly 202). In the embodiment illustrated in FIG. 2A, for example, the emission connector 216 is attached to the first fiber optic connector 208A. In other embodiments, the emission connector 216 may be attachable to other portions of the fiber optic cable, such as the second fiber optic connector 208B or some other portion of the fiber optic cable 206. In FIG. 2A, the launch cable 218 directs (e.g., propagates) the fiber optic tracing signal from the launch module 214, through the emission connector 216, and to the first fiber optic connector 208A or the second fiber optic connector 208B. In this way, one or more launch optical fibers within the launch cable 218 provide for injection of the fiber optic tracing signal into the fiber optic cable 206 for traceability of the fiber optic cable 206 from one or both the ends 210A, 210B (e.g., the first fiber optic connector 208A or the second fiber optic connector 208B) of the fiber optic cable 206.

FIG. 2B is a perspective view of the emission connector 216 of the light launch device 204 disengaged from the first fiber optic connector 208A (e.g., disconnected position, detached position, etc.). The emission connector 216 is configured to engage the first fiber optic connector 208A to direct the optical tracing signal emitted from the light launch device 204 through the emission connector 216 and to the fiber optic cable 206. The emission connector 216 can be removed from the first fiber optic connector 208A after tracing is completed.

In use, a technician selectively engages (e.g., connects, attaches, etc.) the emission connector 216 with the first fiber optic connector 208A (or the second fiber optic connector 208B) in order to start tracing the fiber optic cable. The emission connector 216 can be attached or removed even when the first fiber optic connector 208A and/or second fiber optic connector 208B is engaged with another fiber optic component (e.g., patch panel, first fiber optic component, second fiber optic component, etc.), or any other network component. In the example embodiment illustrated in FIG. 2B, for example, the emission connector 216 vertically engages the first fiber optic connector 208A to inject light into the connector 208A without obstructing the ferrules or connection end of the connector 208A so that the connector 208A can remain connected with the fiber optic component while performing a tracing operation. The emission connector 216 and the first fiber optic connector 208A (or second fiber optic connector 208B) mechanically interact with one another to align their respective optical fibers to direct an optical tracing signal from the emission connector 216 to the first fiber optic connector 208A (or second fiber optic connector 208B).

Once engaged, the user operates the light launch device 204 to inject an optical tracing signal into the first fiber optic connector 208A (or second fiber optic connector 208B) to illuminate the opposite connector (e.g., the second fiber optic connector 208B) through the fiber optic cable 206. In this way, a user can quickly and easily locate the opposite end of the traceable fiber optic cable assembly 202 which streamlines and simplifies the process of tracing or otherwise identifying a fiber optic cable 206 in a congested environment. In an ATL configuration, the user operates the light launch device 204 to inject an optical tracing signal into the first fiber optic connector 208A (or the second fiber optic connector 208B) to illuminate all or part of the length of the fiber optic cable 206. In a combination of EPO and ATL configurations, the user operates the light launch device 204 to inject an optical tracing signal into the first fiber optic connector 208A (or the second fiber optic connector 208B) to illuminate: (1) all or part of the length of the fiber optic cable 206 and (2) the opposite connector (e.g., the second fiber optic connector 208B). As a result, the technician can reliably identify the fiber optic cable 206 in question from amongst many other cables. The cable tracing system 200 may have the advantage of being an optically-activated cable tracing system using only optical tracing elements associated with the fiber optic cable 206 rather than, for example, electrical tracing elements (although electrical or active tracing elements may still be provided in addition to the optical tracing elements, if desired).

Once the tracing operation is completed, a user can disengage the emission connector 216 from the first fiber optic connector 208A (or the second fiber optic connector 208B).

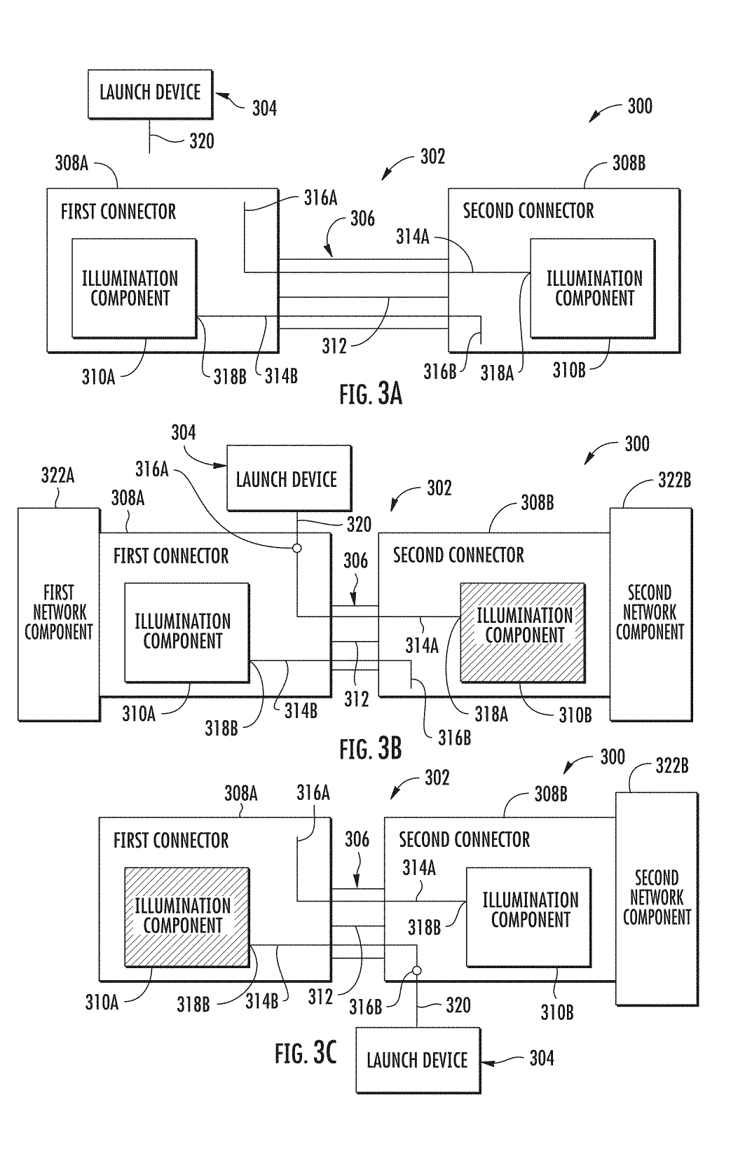

FIGS. 3A-3C are schematic diagrams of another embodiment of an exemplary cable tracing system providing a general overview of how the cable tracing system 300 selectively sends signals to illuminate ends of a cable, thereby allowing a user to trace the ends of a cable. The cable tracing system 300 comprises a traceable cable assembly 302 and a light launch device 304 (as similarly described above with FIGS. 2A-2B). As shown, the traceable cable assembly 302 comprises a first connector 308A and a second connector 308B, and a fiber optic cable 306 therebetween. In some embodiments, the fiber optic cable 306 may be more appropriately referred to as a conduit, without having any data transmission elements. It should be noted that other environments could use this tracing concept, such as other fiber optic deployment applications, electrical interconnects, and potentially liquid or gas conduits, etc. For example, the fiber optic cable 306 may direct fluids such as air or liquid and may be appropriate for use in a medical setting such as IV lines or oxygen tubing.

Any suitable type of connector could be used with the cable tracing system 300. The first connector 308A and the second connector 308B may vary widely depending on the nature of the cable and the components being connected. The specific type of connectors should match the port configuration of the network component and will vary based upon the quantity and type of signals being directed by the cable. The first connector 308A may include a first illumination component 310A, and the second connector 308B may include a second illumination component 310B (as similarly described above with FIGS. 2A-2B and described in more detail below). The fiber optic cable 306 may have a different design or configuration depending on the types of connectors used.

The traceable cable assembly 302 further comprises a data transmission element 312 (e.g., optical data fiber), as well as a first tracing element 314A (e.g., first tracing optical fiber) and/or second tracing element 314B (e.g., second tracing optical fiber) extending between the first connector 308A and the second connector 308B. The data transmission element 312 extends between the first connector 308A and the second connector 308B to carry transmission of one or more data signals (e.g., optical data signals) therebetween. Generally, the data transmission element 312 is a structure capable of carrying a data signal from one end of the fiber optic cable 306 (or any other type of cable) to the other. The data transmission element 312 may be configured to direct an electrical signal, for example, using a copper wire or other electrically conductive material. Alternatively, or in addition, the data transmission element 312 may be configured to direct an optical signal by conducting electromagnetic waves such as ultraviolet, infrared, or visible light to carry data from one location to another. The data transmission element 312 could comprise one or more data transmission elements, which may be of the same type or different types as compared to one another.

The first tracing element 314A and the second tracing element 314B may be used to allow for accurate identification of both ends of the traceable cable assembly 302. In particular, the first tracing element 314A comprises a first input end 316A and a first emission end 318A. The first input end 316A is positioned within the first connector 308A and the first emission end 318A is positioned within or external to the second connector 308B and is in communication with the second illumination component 310B. The second tracing element 314B comprises a second input end 316B positioned within the second connector 308B and a second emission end 318B positioned within or external to the first connector 308A and in communication with the first illumination component 310A. It is noted that although two tracing elements are shown, in certain embodiments, only one tracing element may be used. In some embodiments, the operator can visually identify the first tracing element 314A and/or the second tracing element 314B with or without special equipment, such as an infrared (IR) camera. In some embodiments, discussed below, the first tracing element 314A and the second tracing element 314B are in the form of tracing optical fibers configured to direct and emit tracer light for visualization purposes.

As explained below, the light launch device 304 comprises a launch optical fiber 320 to insert one or more tracing signals into one or both of the first tracing element 314A and the second tracing element 314B. The first and second input ends 316A, 316B of the first and second tracing elements 314A, 314B may be flat cleaved, flat polished or otherwise prepared to efficiently receive the light from the light launch device 304 and may be positioned flush with the connector wall, slightly inside the first and second connectors 308A, 308B or slightly outside the first and second connectors 308A, 308B. Further, one or more illumination components are positioned at the tracing optical fiber emission ends 318A, 318B which provide optical directing and/or optical scattering features to illuminate the first and second connectors 308A, 308B to be easily found by operators.

FIG. 3B is an exemplary schematic diagram illustrating the cable tracing system 300 of FIG. 2A in use to illuminate the illumination component 310B of the second connector 308B. As shown, the first connector 308A is mechanically engaged with and in communication with a first network component 322A, and the second connector 308B is mechanically engaged with and in communication with a second network component 322B. Additionally, the launch optical fiber 320 of the light launch device 304 is in communication with the first input end 316A of the first tracing element 314A. The light launch device 304 emits one or more optical tracing signals (e.g., first optical tracing signal, second optical tracing signal) through the first input end 316A, through the first tracing element 314A, and exits through the first emission end 318A into the second illumination component 310B thereby illuminating the second illumination component 310B. In this way, a user can connect the light launch device 304 to the first connector 308A to locate the second connector 308B by illumination thereof.

FIG. 3C is another exemplary schematic diagram illustrating the cable tracing system 300 of FIG. 2A in use to illuminate the illumination component 310A of the first connector 308A. Here, the first connector 308A is not mechanically engaged or in communication with a network component, but the second connector 308B is mechanically engaged and in communication with the second network component 322B. In this configuration, the launch optical fiber 320 of the light launch device 304 is in communication with the second input end 316B of the second tracing element 314B. The light launch device 304 emits at least one tracing signal through the second input end 316B through the second tracing element 314B and exits through the second emission end 318B in the first illumination component 310A thereby illuminating the first illumination component 310A. In this way, a user can connect the light launch device 304 to the second connector 308B to locate the first connector 308A by illumination thereof, regardless of whether the first connector 308A and the second connector 308B are connected to a first network component 322A or a second network component 322B (e.g., when the second connector 308B is connected to a second network component 322B, and the first connector 308A is not connected to a first network component 322A). As noted above, the launch device 304 is designed such that it can launch light into the first or second connectors 308A, 308B without the need to disconnect the first or second connectors 308A, 308B from respective first and second network components 322A, 322B. Also, as noted above, the light launch device 304 can be connected to the first or second connectors 308A, 308B to illuminate part or all of the fiber optic cable 306 in an ATL configuration.

Now that a general overview of the cable tracing system 300 has been provided, a more detailed discussion of the cable tracing system 200 will be discussed.

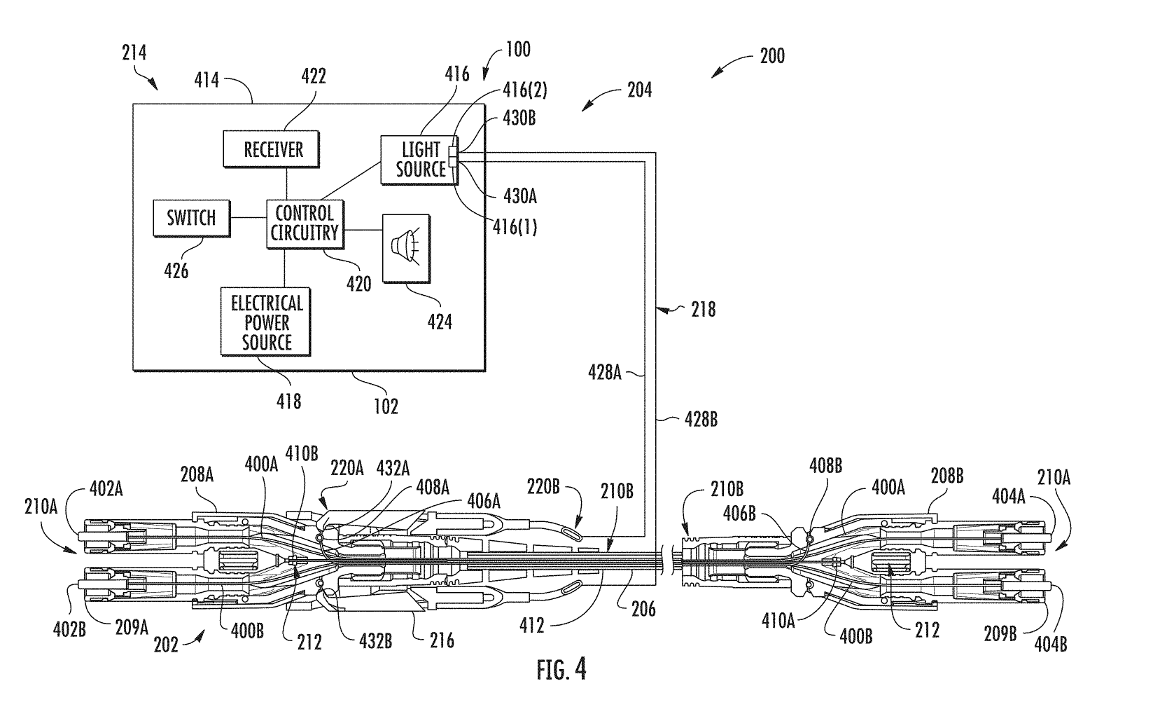

In this regard, FIG. 4 is a more detailed schematic diagram illustrating an exemplary embodiment of the cable tracing system 200 of FIGS. 2A-2B. As shown in FIG. 4, the fiber optic cable 206 may include a first data transmission fiber 400A (e.g., first data optical fiber, first data transmission element) and a second data transmission fiber 400B (e.g., second data optical fiber, first data transmission element). The first data transmission fiber 400A comprises a first end 402A and a second end 404A, and the second data transmission fiber 400B comprises a first end 402B and a second end 404B. The first data transmission fiber 400A and the second data transmission fiber 400B carry optical data signals from the first fiber optic connector 208A to the second fiber optic connector 208B, and/or vice versa. Any number of data transmission fibers could be used, such as depending on networking requirements, data transmission requirements, etc.

Further, the fiber optic cable 206 comprises a first tracing optical fiber 406A and a second tracing optical fiber 406B for direction of a fiber optic tracing signal therethrough, thereby facilitating a user in tracing the ends of the fiber optic cable 206. As noted above, one example of tracing elements is tracing optical fibers 406A, 406B. In particular, the first tracing optical fiber 406A extends along the length of the fiber optic cable 206, and the second tracing optical fiber 406B extends along the length of the fiber optic cable 206 in the opposite direction. The first tracing optical fiber 406A comprises a first input end 408A and a first emission end 410A, and the second tracing optical fiber 406B comprises a second input end 408B and a second emission end 410B. The first input end 408A of the first tracing optical fiber 406A and the second emission end 410B of the second tracing optical fiber 406B are positioned within the first fiber optic connector 208A and are in optical communication with the light source 416, and the first emission end 410A of the first tracing optical fiber 406A and the second input end 408B of the second tracing optical fiber 406B are positioned within the second fiber optic connector 208B.

In some embodiments, each of the first and second input ends 408A, 408B comprise a bend (at or proximate thereto), and each of the first and second emission ends 410A, 410B are generally straight (at or proximate thereto). The bend of the first and second input ends 408A, 408B allow injection of an optical tracing signal into one or more sides of the first and/or second fiber optic connectors 208A, 208B. The straight first and second emission ends 410A, 410B allow emission of an optical tracing signal into a center of the first and/or second fiber optic connectors 208A, 208B, and in particular, into an illumination structure of the first and/or second fiber optic connectors 208A, 208B (described in more detail below). In some embodiments, the emission ends of the tracing optical fibers may also be bent. For example, in some embodiments, the emission ends include a bend of between 0 and 360 degrees. The first and second input ends 408A, 408B are configured to receive light from the light launch device 204 while the emission ends 410A, 410B are configured to emit light. The bends at or near the first and second input ends 408A, 408B may be about 90 degrees (or any other angle) to allow for convenient injection of light into the first and second tracing optical fibers 406A, 406B.

Note that in certain embodiments, the fiber optic cable 206 only uses one of the first tracing optical fiber 406A and the second tracing optical fiber 406B.

The fiber optic cable 206 further comprises a jacket 412 (e.g., hollow tube forming a conduit) substantially surrounding at least a portion of the first data transmission fiber 400A, the second data transmission fiber 400B, the first tracing optical fiber 406A, and the second tracing optical fiber 406B for protection thereof. Alternatively, the first and second data transmission fibers 400A, 400B and/or the first and second tracing optical fibers 406A, 406B may be only partially embedded within the jacket 412 and/or mounted to an outer surface of the jacket 412, or otherwise attached to the jacket 412. The first data transmission fiber 400A and/or the second data transmission fiber 400B may have a core and/or cladding. Further, there may be strength members (e.g., aramid yarns) or other elements located within the fiber optic cable 206 between the first and second data transmission fibers 400A, 400B and the jacket 412.

With continuing reference to FIG. 4, the light launch device 214 is used to inject an optical tracing signal into the first or second fiber optic connectors 208A, 208B or some other portion of the fiber optic cable 206 for transmission of the optical tracing signal to emit from an opposite end of the fiber optic cable 206 (in, in an ATL configuration, to emit from some or all of the length of the fiber optic cable 206) for a user to quickly and easily trace the fiber optic cable 206. The light launch device 214 comprises a housing 414, a launch cable 218, and an emission connector 216. In use, the emission connector 216 is attachable to a portion of the traceable cable (e.g., the first fiber optic connector 208A, the second fiber optic connector 208B). The housing 414 may house a number of elements to enable emission of light into the traceable cable 206. In some embodiments, the housing 414 includes a light source 416 (e.g., laser source), an electrical power source 418 (e.g., one or more batteries), control circuitry 420 which may be respectively connected to other components within the housing 414 (e.g., to control the light source 416), a receiver 422 or other wireless communication components (e.g., to receive commands from an external controller), a speaker 424 (e.g., to allow for the generation of audible signals), a switch 426 (e.g., an on-off switch), and/or one or more user interface features. One or more of these elements could be included on and/or outside the housing 414 at another location of the light launch device 214. For example, in some embodiments, the light source 416 (e.g., a red or green laser) is located at or near the emission connector 216 rather than in the housing 414.

In certain embodiments, the housing 414 may be approximately the size of a standard flashlight or much smaller or larger depending on the application, and it is noted that the FIGURES referenced herein are not intended to be to scale. The housing 414 may be sufficiently durable to protect the components contained within the housing 414 (e.g., in the event of a drop onto a hard surface).

In one embodiment, the light source 416 may emit a wavelength that is chosen to enhance visibility, such as a wavelength as near to 555 nm as possible. In some embodiments, the light source 416 is a 520-540 nm green laser diode, LED (light emitting diode) or super-luminescent diode (SLD). Alternatively, other colors/wavelengths may be emitted, such as red light from approximately 620-650 nm. In other embodiments, non-laser light sources may be used, such as LEDs. Several factors may be considered when selecting an appropriate light source 416, and the factors may include, but are not limited to, visibility, cost, eye safety, peak power, power consumption, size, and commercial availability. While the light source 416 is shown as part of the housing 414, in other embodiments the light source 416 may be part of the emission connector 216 or may be located elsewhere on the light launch device 204, such as on the launch cable 218. In some embodiments, the power of the light source 416 is as high as can be used safely according to industry safety standards, such as a green laser up to 40 mW coupled to a multimode delivery waveguide fiber with core diameter of about 50 microns or more and a numerical aperture about 0.2 or more.

The launch cable 218 (e.g., delivery waveguide, umbilical, etc.) may comprise a first launch optical fiber 428A (e.g., first launch optical fiber) and a second launch optical fiber 428B (e.g., second launch optical fiber). At least a portion of the launch cable is positionable within the interior of the housing for storage and positionable external to the housing in use. In one embodiment, the first and second launch optical fibers 428A, 428B direct green, 520 nm semiconductor laser light and are a high numerical aperture, wide mode field, multimode fiber. In some embodiments, the first and second launch optical fibers 428A, 428B are 0.5 NA, 125 micron core delivery fibers that have a low index of refraction polymer cladding layer directly outside of the core glass.

In some embodiments, the light source 416 includes more than one light emitting features, such as the first light source 416(1) and the second light source 416(2) illustrated in FIG. 4. In certain embodiments, the first launch optical fiber 428A is in optical communication with the first light source 416(1) and the second launch optical fiber 428B is in optical communication with the second light source 416(2).

The first launch optical fiber 428A comprises a first input end 430A and a first emission end 432A, and the second launch optical fiber 428B comprises a second input end 430B and a second emission end 432B. The first and second input ends 430A, 430B are optically connected with the light source 416 (e.g., light source 416(1) and light source 416(2)). In certain embodiments, the first input end 430A is optically connected with the first light source 416(1) and the second input end 430B is optically connected with the second light source 416(2).

The launch cable 218 may be several meters in length, for example, so that the housing 414 of the light launch device 204 can be placed on the ground or other convenient location while the emission connector 216 is coupled with the traceable fiber optic cable assembly 202 several meters away. The emission connector 216 may be mounted to, or otherwise provided at or near the first input end 408A of the first tracing optical fiber 406A or the second input end 408B of the second tracing optical fiber 406B. The emission connector 216 may help provide a high efficiency launch of light into the first tracing optical fiber 406A and/or the second tracing optical fiber 406B.

In use, the emission connector 216 may be attached to the first fiber optic connector 208A, and the first emission end 432A of the first launch optical fiber 428A of the launch cable 218 is aligned with the first input end 408A of the first tracing optical fiber 406A. In this way, a first optical tracing signal that is generated by the light source 416(1) is directed to the first launch optical fiber 428A. The first optical tracing signal then exits the first emission end 432A of the first launch optical fiber 428A and enters the first input end 408A of the first tracing optical fiber 406A positioned in the first fiber optic connector 208A. The first optical tracing signal then travels through the first tracing optical fiber 406A until it exits the first emission end 410A of the first tracing optical fiber 406A positioned in the second fiber optic connector 208B. Accordingly, a user can use the light launch device 204 to locate a second end 210B of the fiber optic cable 206 after attaching the light launch device 204 to a first end 210A of the fiber optic cable 206.

The allowed mechanical tolerances for the first and second launch optical fibers 428A, 428B to the first and second tracing optical fibers 406A, 406B (e.g., tracing fiber) may be less than about +/−100 microns, and preferably less than about +/−50 microns, although broader tolerances are also useable in some embodiments. For example, the first and second launch optical fibers 428A, 428B and first and second the tracing optical fibers 406A, 406B could be selected to enable a larger tolerance. In some embodiments, the first and second launch optical fibers 428A, 428B have a narrower core diameter and mode field diameter (MFD) than the first and second tracing optical fibers 406A, 406B. In some embodiments, for example, the first and second tracing optical fibers 406A, 406B are a 240 micron diameter core 0.5 numerical aperture (NA) plastic optical fiber (POF). In such embodiments, there is 100% spatial overlap of the first and second launch optical fibers 428A, 428B to the first and second tracing optical fibers 406A, 406B for any lateral offset below 57.5 microns. In some embodiments, the NA of the first and second launch optical fibers 428A, 428B and the first and second tracing optical fibers 406A, 406B are the same so very little light is lost from typical angular misalignments of a few degrees. In some embodiments, launch optical fibers 428A, 428B are used with smaller MFDs than 125 microns and lower NAs if the tolerance stack up requires it (e.g., Corning VSDN fiber with an 80 micron MFD and a 0.29 NA).

In some embodiments, the light sources 430A, 430B both emit light during a tracing operation. Because both light sources 430A, 430B emit light, both the first and second launch optical fibers 428A, 428B receive and transmit light, and the emission connector 216 emits light from both the first emission end 432A of the first launch optical fiber 428A and the second emission end 432B of the second launch optical fiber 428A. As discussed in more detail below, the light sources 430A, 430B may emit light simultaneously or non-simultaneously.

As illustrated in FIG. 4, the fiber optic cable assembly 202 may be configured such that light from only one of the first launch optical fiber 428A and the second launch optical fiber 428A actually enters the first and second tracing optical fibers 406A, 406B. As discussed above, each fiber optic connector 208A, 208B of the traceable fiber optic cable assembly 202 includes an input end (e.g., input end 408A) of one of the tracing optical fibers (e.g., first tracing optical fiber 406A) and an emission end (e.g., emission end 410B) of the other tracing optical fiber (e.g., second tracing optical fiber 406B). As such, light from only one of the first and second launch optical fibers 428A, 428B of the launch cable 218 of the launch module 214 enters one of the tracing optical fibers (e.g., first or second tracing optical fibers 406A, 406B). However, by emitting light from both the first emission end 432A of the first launch optical fiber 428A and the second emission end 432B of the second launch optical fiber 428A, the emission connector 216 of the launch module 214 need not be keyed for only one connector (e.g., only the first connector 208A or only the second connector 208B) or specifically aligned with a connector in order to inject light therein. In other words, the emission connector 216 can be connected to either the first or second connectors 208A, 208B so that either the first emission end 432A of the first launch optical fiber 428A or the second emission end 432B of the second launch optical fiber 428A is aligned with an input end (e.g., input end 408A or input end 408B) of one of the tracing optical fibers. In addition, by emitting light from both the first emission end 432A of the first launch optical fiber 428A and the second emission end 432B of the second launch optical fiber 428A, the same connector can be used to inject light into both the first and second connectors 408A, 408B. This also enables support of either orientation of the emission connector 216 (e.g., reversible Uniboot connector) without requiring inspection or trial and error.

As discussed above, in certain embodiments, the light source 416 may include more than one light source (e.g., light sources 416(1), 416(2)) or emit two tracing signals (e.g., by using an optical splitter or switch). In some embodiments, using two light sources (e.g., light sources 416(1), 416(2)) may increase available optical power, such as to overcome a high optical loss budget and/or relax tolerances in other system components that may incur additional optical loss. In certain embodiments, the lasers have an output power above 50 mW (e.g., above ˜80 mW) and/or power dissipation in excess of 1.5 W. In certain embodiments, the two light sources 416(1), 416(2) emit green lasers, due to good visibility to the eye (e.g., green provides 4× visibility over red), as well as available laser power from compact laser diodes. However, other colors could be used.

In certain embodiments, to mitigate thermal issues (e.g., two simultaneously operated high power light sources 416(1), 416(2)) and extend battery life (e.g., minimize power consumption), the two light sources 416(1), 416(2) are not illuminated simultaneously. For example, in some embodiments, the two light sources 416(1), 416(2) alternate emission. This may lower the peak current draw as well as lower heat dissipated by both light sources 416(1), 416(2). As noted above, in certain embodiments, only one laser light reaches the far end connector (e.g., fiber optic connector 208A, 208B), so that there is a pulsing effect (i.e., blinking light effect), which may effectively increase visibility as it is more noticeable to the eye.

In certain embodiments, for example, the first light source 416(1) has a pulse duration of 50% of the cycle duration and the second light source 416(2) has a pulse duration that is 50% of the cycle duration. Thus, for example, for a cycle duration of 10 seconds, each light source 416(1), 416(2) would have a pulse duration of 5 second. In other words, in some embodiments the first light source 416(1) emits light during 50% of a cycle duration and the second light source 416(2) emits light during the other 50% of the cycle duration. It is noted that, as used herein, each repeating cycle last for a certain period of time, called a cycle duration. The cycle duration is measured from the change of state of the first light source (e.g., light source 416(1)) from off to on, although the cycle could be measured from other events. Each cycle includes at least one light pulse having a pulse duration, which is the portion of the cycle duration during which the light source (e.g., light source 416(1) or light source 416(2)) is on or emitting a tracing signal.

In some embodiments, the pulse duration of each light source (e.g., light sources 416(1), 416(2)) is less than 50% of the cycle duration to further reduce power dissipation and heat production, resulting in higher available laser power and/or longer battery life. For example, in certain embodiments, each light source has a pulse duration that is less than about 300% of the cycle duration such that the lasers are engaged, and dissipate power and heat, only a total of about 60% of the cycle duration.

In some embodiments, as discussed above, the pulse duration of each laser occurs at different portions of the cycle duration. Thus, for example, in a cycle duration of 10 seconds where each laser has a pulse duration of 3 seconds, the cycle may appear as follows: the first light source 416(1) engages for 3 second, neither light source is engaged for 2 seconds, the second light source 416(2) engages for 3 seconds, and then neither light source is engaged for 2 seconds. Thus, there is a portion of each cycle duration wherein neither the first or the second light source 416(1), 416(2) is engaged.

In some embodiments, the first light source 416(1) is configured to emit the first optical tracing signal in each instance of the repeating cycle and the second light source 416(2) is configured to emit the second tracing optical signal in each instance of the repeating cycle. The first light source 416(1) may emit the first optical tracing signal for about 25%-35% of the cycle duration and the second light source 416(2) may emit the second optical tracing signal for about 25%-35% of the cycle duration.

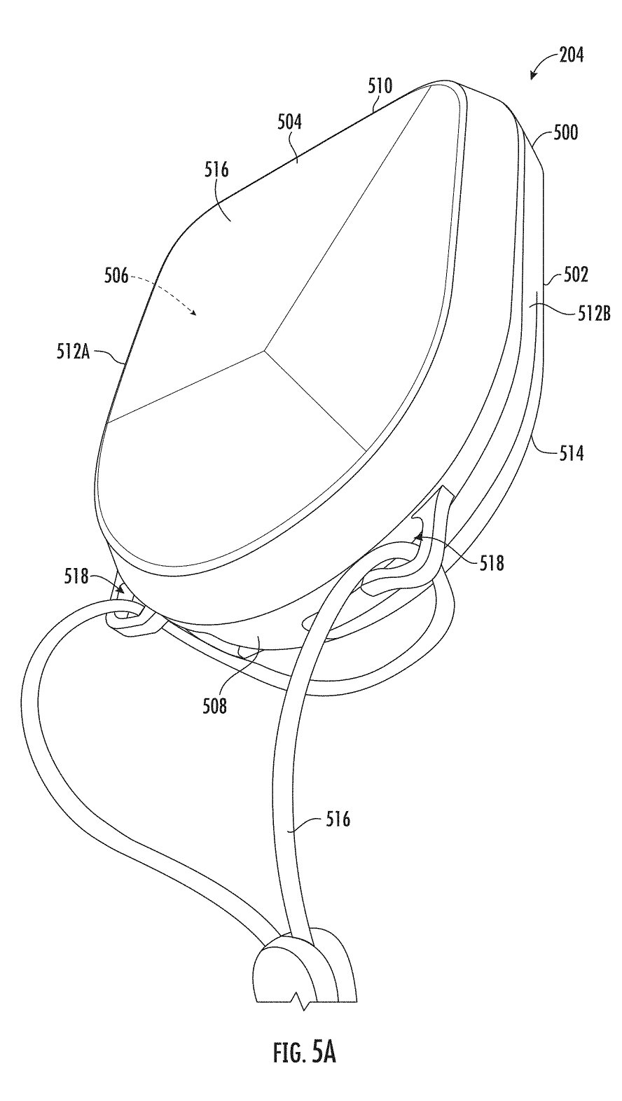

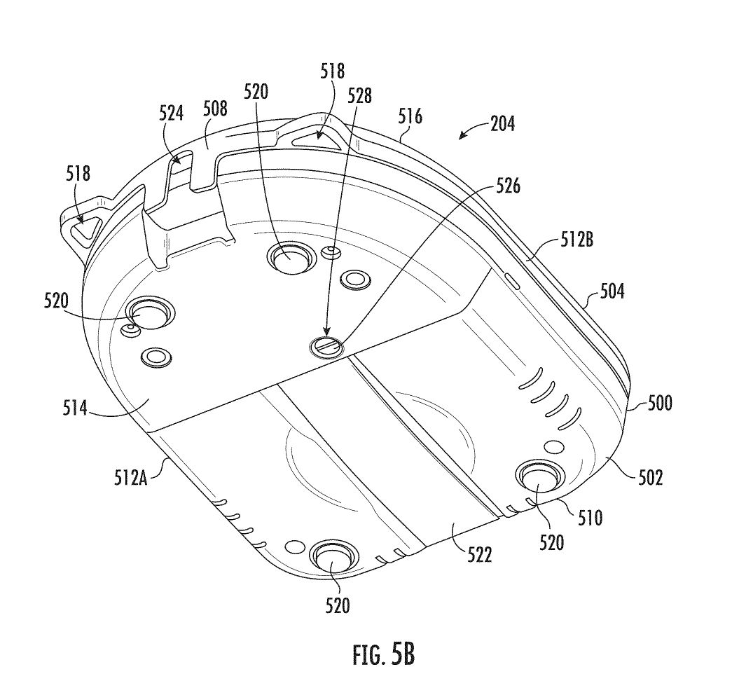

FIGS. 5A-5B are views of the light launch device 204 of FIGS. 2A-2B with a cover 504 (may also be referred to as a lid) in a closed orientation. As discussed above, the light launch device 204 may provide improved performance, operation, storage and/or usability. In certain embodiments, for example, the light launch device provides an all-optical method of tracing a cable (i.e., no electrical connections with or additions to fiber optic cable 206). The light launch device 204 eases operation due to simple winding and storage of the launch cable 218, simple one screw cable replacement, and adjustable power (e.g., for Class 3R NAFTA (North American Free Trade Agreement), Class 2 EMEA (Europe, Middle East, and Africa), etc.). In certain embodiments, the light launch device 204 includes a high power in order to overcome a high loss budget and maintain visibility, an acceptable eye safety class despite the high power (e.g., Class 2, or Class 3R), and/or a two fiber output, such as to be compatible with a reversible LC connector on the end of the launch cable 218 (regardless of polarity). Referring to FIG. 5A, the light launch device 204 includes a housing 500 including a body 502 and the cover 504 which is shown in the closed orientation. The body 502 and the cover 504 define an interior 506 therebetween. The light launch device 204 defines a front side 508, back side 510, left side 512A, right side 512B, bottom side 514, and top side 516. In certain embodiments, the cover 504 is made from hard plastic. The cover 504 provides protection without the need for a separate external case, which may be easily lost or not used, etc.

In certain embodiments, the light launch device 204 further includes a hanging strap 516 attached to the housing 500, such as by being threaded through apertures 518 at the front side 508 of the cover 504 of the light launch device 204. The hanging strap 516 may be used to hang the light launch device 204 (e.g., from a hook on the side of the equipment rack). Attaching the hanging strap 516 at the front side 508 of the cover 504 allows hanging of the light launch device 204 with the cover 504 in an open orientation (see FIG. 2A).

Referring to FIG. 5B, the light launch device 204 includes a plurality of rubber feet 520 at the bottom 514 of the light launch device 204 to prevent movement of the light launch device 204 when placed on a surface (e.g., table). Further, the light launch device 204 includes a hand strap 522 at the bottom side 514 of the light launch device 204. The hand strap 522 extends from the back 510 of the light launch device 204, along at least a portion of the bottom surface of the body 502 of the housing 500 toward the front 508 of the light launch device 204. Further, the hand strap 522 may be positioned about midway between the left side 512A and the right side 512B, such that the hand strap 522 may be comfortably placed in a user's left or right hand for one handed use. Further, the hand strap 522 may be recessed to allow laying the light launch device 204 flat on a table or other surface. Thus, the light launch device 204 provides flexible usage modes (e.g., hook, handheld, table/floor, open/closed, etc.). It is noted that whether placed on a surface or held in a hand, the cover 504 does not interfere with usage of the light launch device 204 (e.g., the cover may be open or closed).

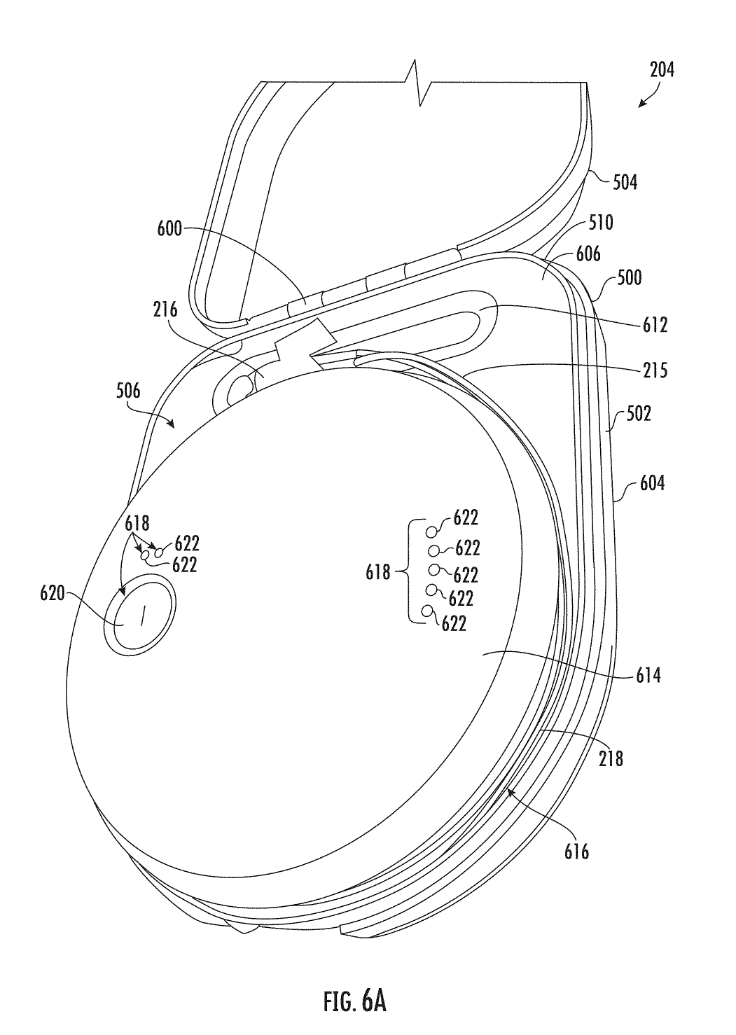

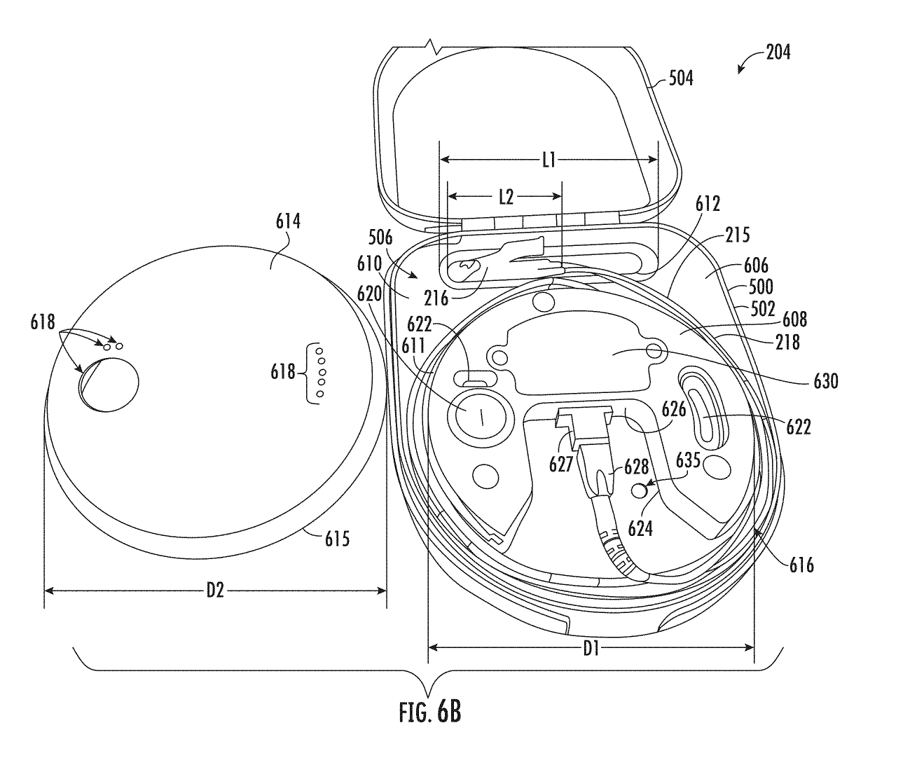

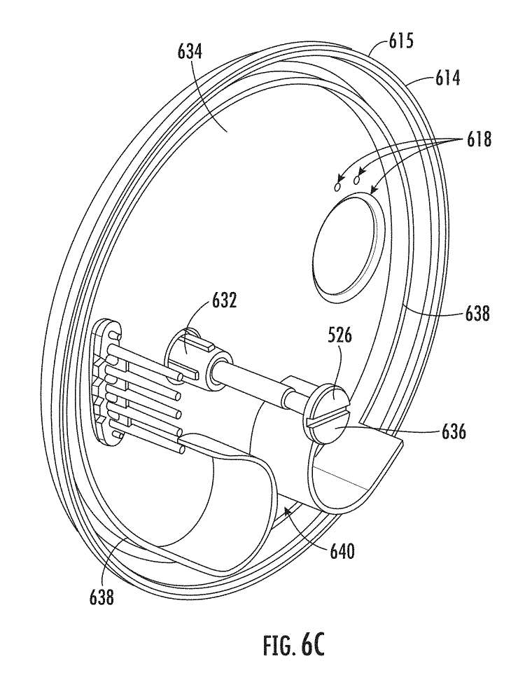

In the embodiment illustrated in FIG. 5B, the cover 504 of the light launch device 204 includes a passage 524. In other embodiments, either the cover 504, the body 502, or the cover 504 and the body 502 may define the passage 524. The passage 524 provides access to the interior 506 of the light launch device 204 and is configured to receive at least a portion of the launch cable 218 (see e.g., FIGS. 2A and 6A) therein to allow for positioning the emission connector 216 (see e.g, FIGS. 2A and 6A) external to the housing 500 when the cover 504 is in the closed position. Thus, the emission connector 216 is positionable within the interior 506 of the housing 500 (e.g., for storage) or external to the housing 500 (e.g., when the emission connector 216 is in use). In this way, the launch cable 218 can extend from the interior 506 to the exterior of the housing 500 when the cover 504 is in the closed position. In other words, the cover 504 does not interfere with operation of the light launch device 204, and operation of the light launch device 204 is possible with the cover 504 open or closed. Further, the light launch device 204 may still be hung, handheld, or placed on a table when the light launch device 204 is closed and in use. In other embodiments, the body 502 may define the passage 524 or the cover 504 and the body 502 may together define the passage 524.

The light launch device 204 also includes a screw 526 inserted through a hole 528 at the bottom 514 of the light launch device 204 and extending though the body 502 to engage a faceplate 614 (see FIGS. 6A-6C) of the light launch device 204 to secure the faceplate 614 to the body 502.

FIGS. 6A-6C are views of the light launch device 204 of FIGS. 2A-2B and 5A-5B with the cover 504 in an open orientation. Referring to FIG. 6A, the cover 504 of the light launch device 204 is hingedly connected to the body 502 of the housing 500 by a hinge 600 at a back side 510 of the light launch device 204. Connecting the cover 504 to the body 502 prevents the cover 504 from being misplaced by a user, or from the unit being stored or transported without a protective lid. The cover 504 may be selectively pivoted between a closed position (as in FIGS. 5A-5B) and an open position (as in FIGS. 6A-6B).

Referring again to FIG. 6A, in some embodiments the body 502 of the housing 500 includes a bottom housing body 604 and a top housing body 606. Referring now to FIG. 6B, the body 502 includes a hub 608 upwardly extending from an upper surface 610 of the body 502 and defining an outer perimeter 611. The outer perimeter 611 is generally circular shaped and has a diameter D1. The upper surface 610 defines a storage slot 612 (e.g., rubber slot and/or other flexible material) positioned between hub 608 and the hinge 600 and extending between the left side 512A and the right side 512B. In certain embodiments, the storage slot 612 includes or consists of two rubber pads. The storage slot 612 provides an area for storing the emission connector 216 of the launch cable assembly 215.

Referring to FIGS. 6A and 6B, the body 502 of the housing 500 further defines a internal raceway 616 for storing a portion of the launch cable. In other words, at least a portion of the launch cable 218 is positionable in the internal raceway 616, for example, by wrapping the portion of the launch cable 218 around the internal raceway 616. A faceplate 614 is positioned within the interior 506 of the housing 500 when in use and has a diameter D2 which is greater than the diameter D1 of the hub 608. Thus, in some embodiments, an outer perimeter 615 of the faceplate 614 extends past the outer perimeter 611 of the hub 608 to define the internal raceway 616 between the hub 608 of the body 502 and the faceplate 614. At least a portion of the launch cable 218 of the launch cable assembly 215 is positioned within the internal raceway 616. In particular, at least a portion of the launch cable 218 is wrapped around the outer perimeter 611 of the hub 608 and secured between the hub 608 and the faceplate 614 for storage. This allows for convenient storage and transportation of the launch cable 218 and emission connector 216, which avoids wearing or breaking of the end connector (which may require replacement or return for repair by the manufacturer).

The emission connector 216 of the launch cable assembly 215 can be removably secured within the storage slot 612. In other words, the storage slot 612 is configured to selectively retain the emission connector 216. In particular, a length L1 (also called a :slot length”) of the storage slot 612 is greater than a length L2 (also called a “connector length”) of the emission connector 216. In certain embodiments, the storage slot 612 has a length L1 that is at least twice the length L2 of the emission connector 216. The emission connector 216 can be placed at any point along the length L1 of the storage slot 612 to accommodate for variations in wrapping the launch cable 218 around the hub 608. In certain embodiments, the storage slot 612 is of a different shape and the rubber sides of the storage slot 612 could incorporate flaps to further secure the emission connector 216 therein. The storage slot 612 is positioned within the housing 500 and outside the internal raceway 616. The storage slot 612 enables a space to safely store the emission connector 216 while allowing for tolerance in cable length of the launch cable 218, which affects the exact location of the emission connector 216.

With continuing reference to FIGS. 6A-6C, the faceplate 614 further defines a plurality of apertures 618 that provide access through the faceplate 614 to operational components on the hub 608 of the body 502. The operational components include a power button 620 and light indicators 622. In particular, the simple, single power button 620 eases operation.

In some embodiments, the body 502 also includes a bulkhead 626. The light source 416 and the input end 430A of the launch optical fiber (e.g., the launch optical fiber 704A and/or the launch optical fiber 704B) are in optical communication with each other via an optical connector receptacle 627 on the bulkhead 626. The faceplate 614 is also positioned over a bulkhead 626 to protect the optical connector receptacle 627 of the bulkhead 626 and the mechanical engagement (e.g., optical couple) between the input connector 628 of the launch cable 218 and the internal components of the launch module 214 (see, e.g., description of FIG. 4 including description of switch 426, receiver 422, light source 416, electial power sourse 418, etc.). In certain embodiments, the bulkhead 626 includes a shuttered connector receptacle (e.g., duplex shuttered LC connector receptacle) to allow a better eye safety rating as the concentrated laser light is blocked by the shutter if the operator inadvertently leaves the device on (or turns it on) while the launch cable 218 is disconnected.

The faceplate 614 discourages frequent disconnection of the launch cable 218 (which may cause premature wear of the optical connector receptacle 627 of the bulkhead 626), such that the user will only take the time and effort to remove the launch cable 218 when the launch cable 218 needs to be repaired or replaced (e.g., for maintenance). This prevents wearing out of the optical connector receptacle 627 of the bulkhead 626 from repeated connections without affecting the light launch device 204. Further, the faceplate 614 improves the user experience as any light escaping from the optical connector receptacle 627 of the bulkhead 626 is blocked by the faceplace 614 when the faceplate is in place.

Referring to FIG. 6B, the faceplate 614 is removable from the body 502, thereby providing access to the optical connector receptacle 627 of the bulkhead 626 (may also be referred to as a bulkhead connector receptacle), such as for removal of the launch cable 218 when a replacement is needed.

The bulkhead 626 is positioned within the internal raceway 616, or, in other words, the internal raceway 616 encircles the bulkhead 626. The hub 608 includes the outer perimeter 611, and a recessed perimeter 624 which extends inwardly from the outer perimeter 611. The cable assembly 215 includes the input connector 628 (at an opposite end of the cable 218 as the emission connector 216) that is connectable or coupleable to the optical connector receptacle 627 of the bulkhead 626. The at least one light source 416 (see FIG. 4) is in communication with the optical connector receptacle 627 of the bulkhead 626.

The hub 608 further includes a hub plate 630, which is removable to allow selective access to body interior defined between the bottom housing body 604 and the top housing body 606.

Referring to FIG. 6C, the faceplate 614 of the light launch device 204 includes a screw attachment 632 extending at a back surface 634 of the faceplate 614. In particular, the screw 526 extends through the hole 528 at the bottom 514 of the bottom housing body 604 through the body 502 through a hole 635 at an upper surface 610 of the top housing body 606 into the screw attachment 632 of the faceplate 614. The screw attachment 632 is threaded and configured to engage the screw 526 to secure the faceplate 614 to the body 502 of the light launch device 204. In this way, the head 636 of the screw 526 is accessible from the bottom 514 of the light launch device 204.

The faceplate 614 further defines a wall 638 extending at least partially circumferentially around the perimeter 615 of the faceplate 614. The wall 638 is at least slightly larger than the perimeter 611 of the hub 608. The wall 638 further defines a gap 640 to receive at least a portion of the launch cable 218 therein to permit the cable to extend from the optical connector receptacle 627 of the bulkhead 626 to an exterior of the light launch device 204 while the faceplate 614 is attached to the hub 608.

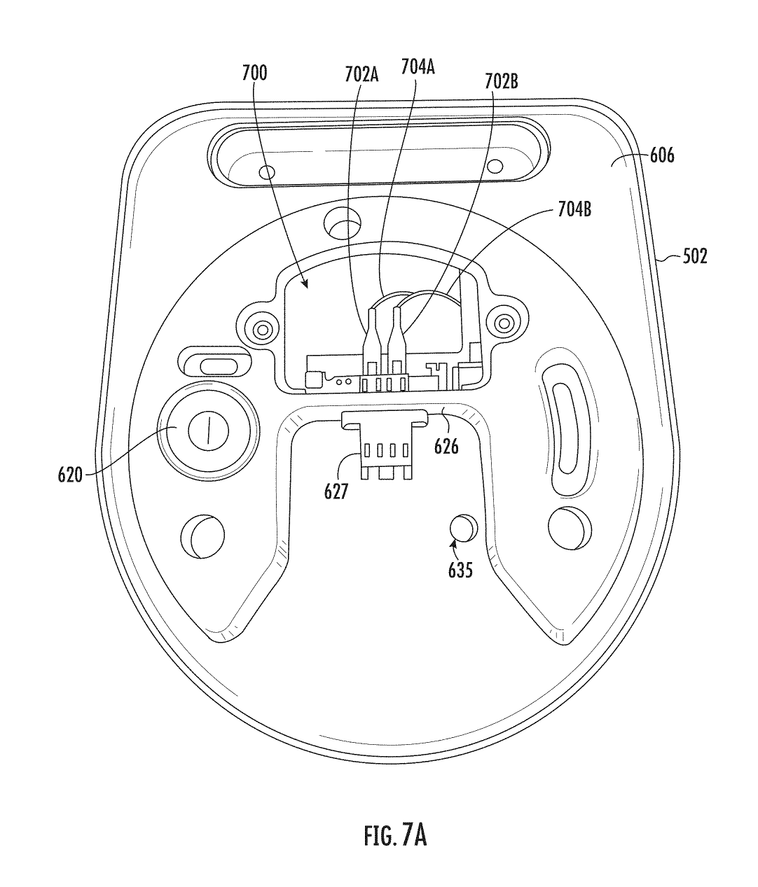

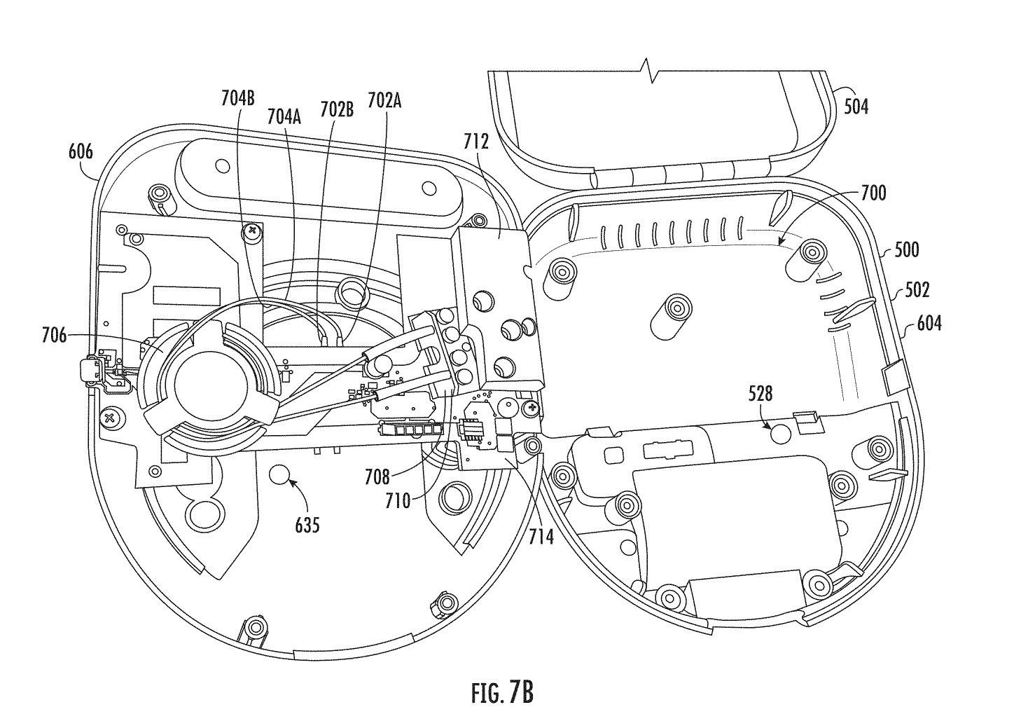

FIGS. 7A-7B are views of the light launch device 204 of FIGS. 2A-2B and 5A-6 illustrating a body interior 700 and interior connections and components. In particular, FIG. 7A is a perspective view of the light launch device 204 with the hub plate 630 (see FIG. 6B) removed. FIG. 7B is a perspective view of internal components of the light launch device 204. The internal components include a first emission end 702A of a first launch optical fiber 704A and a second emission end 702B of a second optical fiber 704B. The internal components further include a spool 706 (or spool stack), with at least a portion of the first launch optical fiber 704A and/or second optical fiber 704B wrapped around the spool 706. As fiber optics components such as Laser diodes and Photo diodes are usually provided with excess fiber, the excess fiber may be wrapped on a spool 706 (may also be referred to as a fiber management spool).

At least a portion of the first launch optical fiber 704A and the second optical fiber 704B is in communication with the laser package 708 (which may include, for example, the first light source 416(1) and the second light source 416(2) illustrated in FIG. 4). Further, the laser package 708 is positioned adjacent or near a shared or common heatsink 712. In particular, the heatsink 712 is mounted to the PCB 714 along with the laser package 708. In certain embodiments, the heatsink 712 is significantly larger than the laser package 708 (e.g., to avoid the need for two large heatsinks, as well as simplify assembly of the tool). Internal components may further include a printed circuit board (PCB) 714 among other circuitry.

Referring to FIGS. 2A, 4, and 5A-7B, the light launch device 204 for a traceable fiber optic cable assembly 202 includes a housing 500, at least one light source 416, and a launch cable assembly 215. The housing 500 includes a body 502 and a cover 504 defining an interior 506 therebetween. The body 502 includes a bulkhead 626. The housing 500 further includes a faceplate 614 removably attached to the body 502 and covering the bulkhead 626 when attached to the body 502. The at least one light source 416 is configured for generating an optical tracing signal positioned within the interior 506 of the body 502 of the housing 500 and in communication with the optical connector receptacle 627 of the bulkhead 656. The launch cable assembly 215 includes a launch cable 218 including a first launch optical fiber 704A, with an input connector 628 at a first end of the launch cable 218, and an emission connector 216 at a second end of the launch cable 218. The input connector 628 is coupled to the optical connector receptacle 627 of the bulkhead 656. The emission connector 216 is positionable within the interior 506 of the housing 500. The emission connector 216 is configured to selectively engage a fiber optic connector 208A, 208B of a traceable fiber optic cable 202. The first launch optical fiber 428A includes a first input end 430A and a first emission end 432A. The first emission end 432A is positioned in the emission connector 216 and the first input end 430A is in optical communication with the light source 416 to receive the optical tracing signal therefrom. The launch cable 218 is positionable within the interior 506 of the housing 500.

In certain embodiments, the light launch device 204 is configured to generate a first optical tracing signal and/or a second optical tracing signal and the launch cable assembly 215. The launch cable assembly 215 includes an input connector 628 to receive the first optical tracing signal and the second optical tracing signal from the light source 416, an emission connector 216 configured to selectively engage a traceable fiber optic cable assembly 202 (for example, the fiber optic connector 208A of a traceable fiber optic cable 202), a first launch optical fiber 428A, and a second launch optical fiber 428B. The first launch optical fiber 428A has a first input end 430A and a first emission end 432A. The first input end 430A is in communication with the light source 416 to receive the first optical tracing signal therefrom, and the first emission end 432A is positioned in the emission connector 216. The second launch optical fiber 428B has a second input end 430B and a second emission end 432B. The second input end 430B is in communication with the light source 416 to receive the second optical tracing signal therefrom, and the second emission end 432B is positioned in the emission connector 216. In certain embodiments, the light source 416 is configured to alternate emission of the first optical tracing signal into the first launch optical fiber 428A and emission of the second optical tracing signal into the second launch optical fiber 428B. In certain embodiments, the first optical tracing signal comprises a green laser signal. In certain embodiments, the light source 416 emits the first optical tracing signal and the second tracing optical signal in each instance of a repeating cycle and each repeating cycle comprises a cycle duration. In certain embodiments, the light source 416 emits the first optical tracing signal for about 25%-35% of each cycle duration, and/or the light source 416 emits the second optical tracing signal for about 25%-35% of each cycle duration. In certain embodiments, the light launch device 204 includes a heatsink 712 positioned within the housing 500. In certain embodiments, the at least one light source comprises a first laser source 416(1) and a second laser source 416(2) in thermal communication with the heatsink 712, and the heatsink 712 is configured to dissipate heat generated by the first laser source 416(1) and the second laser source 416(2).

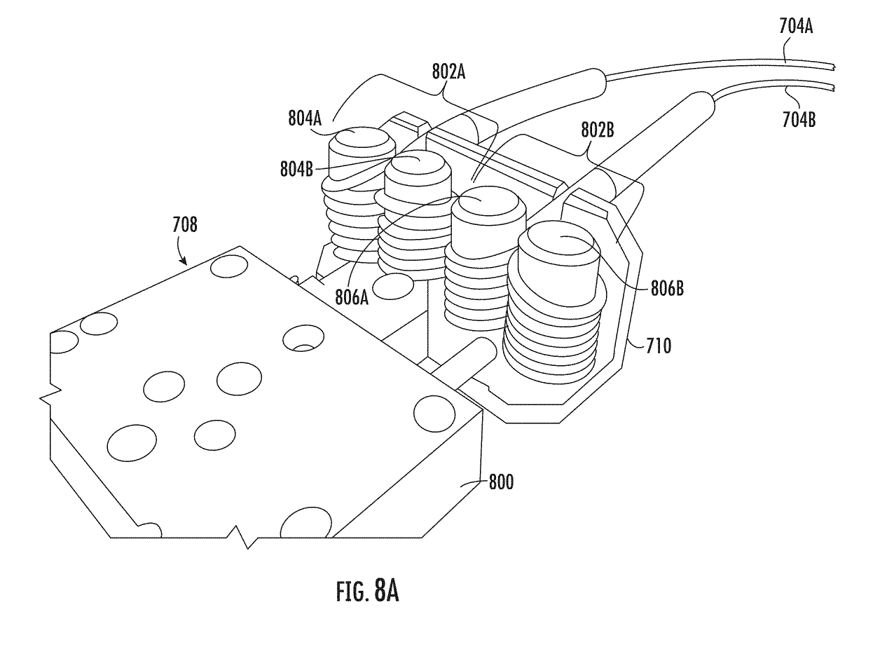

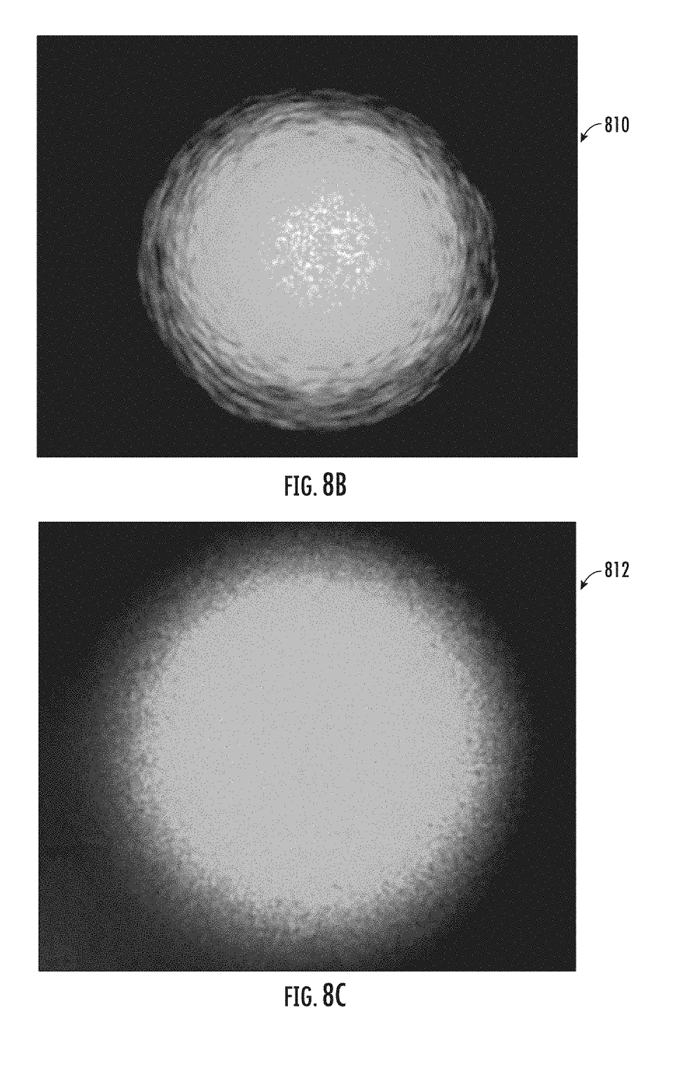

FIG. 8A is a perspective view of the laser package 708 of the light launch device 204 of FIGS. 2A-2B and 5A-7B. In certain embodiments, the maximum power of some lasers (e.g., 80 mW) may result in a beam emitted by the laser at or above a desirable level, such as a threshold eye safety classification (e.g., eye safety classification 3B). To increase eye safety, the light launch device 204 expands the beam divergence emitted from the light launch device 204. For example, in certain embodiments, a high NA (numerical aperture) fiber is used which has a more divergent beam. In certain embodiments, to cause the beam shape to fill more of the potential emitting cone, a form of mode homogenization is used. In certain embodiments, a light diffusing fiber may be used. In certain embodiments, a step index fiber wrapped in a figure eight around two mandrels may be used, as discussed below. The use of such fibers with a large core further increases the efficiency of the light coupling from the laser into the fiber, which in turn increases available loss budget.

In some embodiments, the laser package 708 further includes a laser housing 800 for the light source 416 (see FIG. 4). In certain embodiments, the laser housing 800 is a duplex laser housing with a bracket 710 attached thereto. The bracket 710 includes a first pair of mandrels 802A for the first launch optical fiber 704A and a second pair of mandrels 802B for the second optical fiber 704B. The first pair of mandrels 802A and the second pair of mandrels 802B may decrease the optical intensity of the light within the first launch optical fiber 704A and the second launch optical fiber 704B. The first pair of mandrels 802A includes a first mandrel 804A (may also be referred to as column, etc.) and a second mandrel 804B proximate the first mandrel 804A. The first launch optical fiber 704A is wrapped around the first mandrel 804A and the second mandrel 804B in a general figure eight pattern. Similarly, the second pair of mandrels 802B includes a first mandrel 806A (may also be referred to as column, etc.) and a second mandrel 806B proximate the first mandrel 806A. The second launch optical fiber 704B is wrapped around the first mandrel 806A and the second mandrel 806B in a general figure eight pattern. In certain embodiments, two mandrels 804A, 804B are positioned within the housing 500 (e.g., the body 502) (see FIGS. 5A-5B), and the first launch optical fiber 704A is wrapped in a figure eight configuration around the two mandrels 804A, 804B.

The figure eight pattern results in the first launch optical fiber 704A and the second launch optical fiber 704B switching between clockwise and counter-clockwise winding as it alternates between mandrels 804A-806B. Bending the first launch optical fiber 704A and the second launch optical fiber 704B increases the incident angle of the light at the interface with the clad, where steeper angles transfer some of the light to higher modes. This results in the beam becoming more homogenous (i.e., the projected light becomes more even distributed). More windings and tighter windings increase the degree of homogenization.

FIG. 8B is a view illustrating light emission intensity from an optical fiber without use of the laser package 708 of FIG. 8A. In other words, FIG. 8B illustrates a beam output 810 from a step index pigtail without a mandrel wrap. Comparatively, FIG. 8C is a view illustrating light emission intensity from an optical fiber with use of the laser package 708 of FIG. 8A. In other words, FIG. 8C illustrates a beam output 812 from a step index pigtail with a fiber mandrel wrapped five times in a figure eight format. Further, the use of such fibers with a large core further increases the efficiency of the light coupling from the laser into the fiber, which in turn increases available loss budget. In certain embodiments, Polymer Clad Silica fiber is used.

Referring again to FIG. 2A, in certain embodiments the light launch device 204 includes a WiFi interface for remote control and monitoring. In particular, a WiFi (or any other wireless technology or protocol) module can be incorporated into the light launch device 204 which could be used for various functions, such as, for example, switching a laser on/off, adjusting power, adjusting blinking frequency, choosing laser output in an embodiment of a tool with multiple outputs feeding multiple cables, and/or any other additional controllable function the light launch device 240 might have.

In certain embodiments, the light launch device 204 includes a power control to adjust a laser power level, such as, for example, for battery consumption when lower power is sufficient, and/or to adjust visibility versus glare, etc. In certain cases, it may be desirable to adjust the power level. For example, for a short cable, or with low loss budget (e.g., in order to reduce glare or reflections at far end), and/or to conserve battery power where brightness not needed (e.g., in a darkened area).

In certain embodiments, the light launch device 204 includes an adjustable cycle duration or pulse duration. In certain applications, in a data center, for example, more than one technician may be using a light launch device 204. In certain embodiments, the light launch device includes an adjustable blinking time period or frequency to allow for differentiating between light from two or more light launch devices 204.

In certain embodiments, the light launch device 204 is configured to transmit an identification code sent over the tracing fiber. In a situation where multiple tools (or multiple outputs of a multi-output tool) are in use, it can be desirable for each light launch device 204 to have a unique identification code in order to confirm identification of the correct far end connector.

In certain embodiments, the light launch device 204 is configured to transmit a voice link over the tracing fiber. In certain embodiments, the light launch device 204 functions as a polarity check, for example, by emitting different colored light in each of the tracing fibers (e.g., blue on right and orange on left). In certain embodiments, the light launch device 204 includes two different colored lasers (i.e., instead of two identical green lasers).

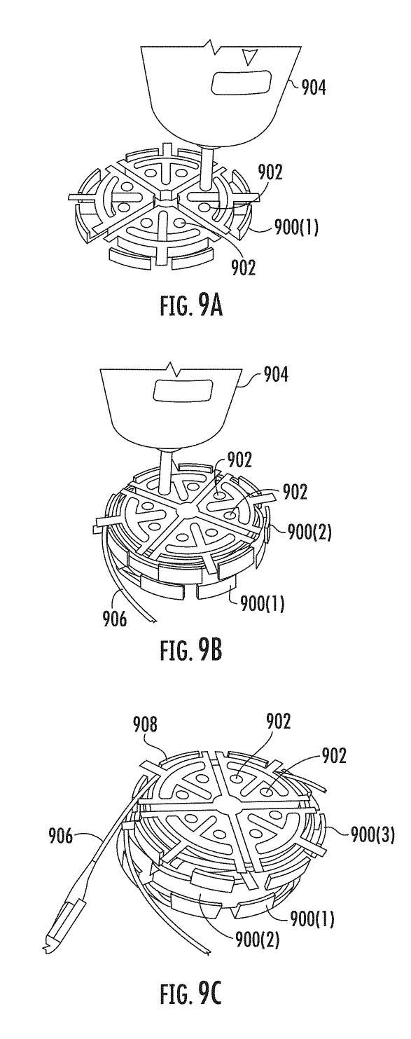

FIGS. 9A-9C are views illustrating spools to store extra length of fiber within the light launch device 204 of FIGS. 2A-2B and 5A-7B. Referring to FIG. 9A, a first spool 900(1) includes a plurality of holes 902 with a device 904 applying screws (or other fasteners) through the holes 902 in the first spool 900(1) to a surface inside the housing 500 (see FIG. 5A). Similarly, referring to FIG. 9B, a second spool 900(2) (with fiber 906 wrapped around the second spool 900(2)) is attached to the first spool 900(1) by applying screws or other fasteners through the holes 902 in the second spool 900(2) to attach the second spool 900(2) to the first spool 900(1). Referring to FIG. 9C, a third spool 900(3) is attached to the second spool 900(2) by applying screws or other fasteners through the holes 902 in the third spool 900(3) to attach the third spool 900(3) to the second spool 900(2). In this way, the plurality of spools 900(1)-900(3) form a spool stack 908. In certain embodiments, when a new spool 900 is added, or a spool 900 (and/or associated fiber 906) needs to be replaced, the spools must be disassembled in the reverse order that they were assembled. For example, to replace the second spool 900(2) would require disassembly of the third spool 900(3) first. This may be a tedious process that might also damage the other components.

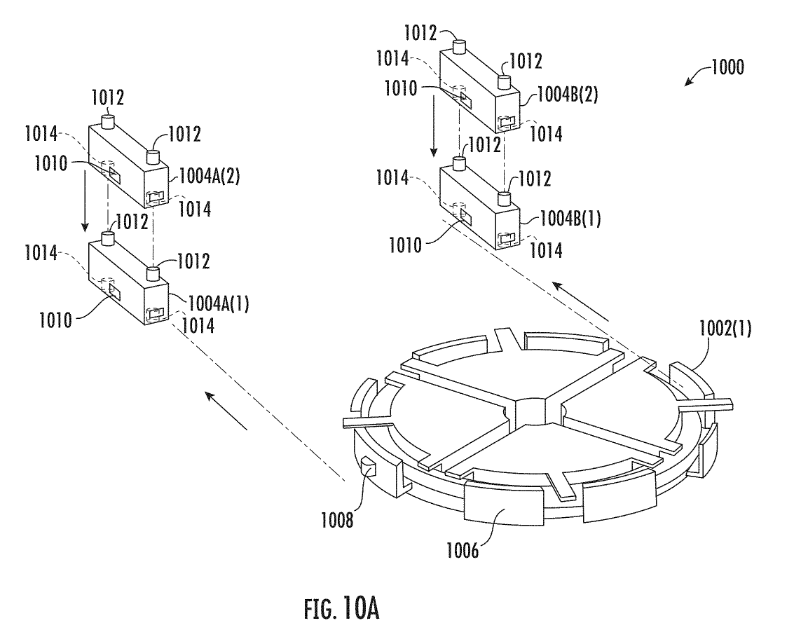

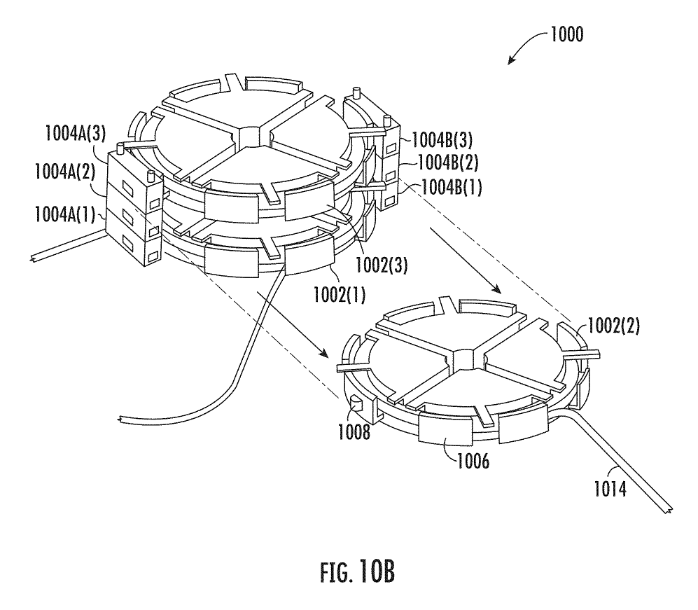

FIGS. 10A-10B are views illustrating assembling and removing spools of another exemplary embodiment of a spool stack 1000 of the light launch device 204 of FIGS. 2A-2B and 5A-7B. The spool stack 1000 provides for easy attachment and disassembly of the fiber management spools without a need to disassemble all of the spools when one of the optical components needs to be replaced. In particular, the device allows rolling each fiber onto a spool separately during the assembly and separate removal of each spool. In particular, the fixture saves installation and replacement time and reduces the likelihood for damage to the fiber or the optical components.

Referring to FIG. 10A, a first spool 1002(1) includes a plurality of circumferential wall segments 1006, and two tabs 1008 extending outwardly from two of the circumferential wall segments 1006. The tabs 1008 are at opposite ends of the first spool 1002(1). The spool stack 1000 further includes a plurality of side supports 1004A(1)-1004B(2) (referred to generally as side supports 1004).

The first left side support 1004A(1) and the first right side support 1004B(1) are mounted to a surface of the light launch device 204 (not shown in FIG. 10A). Each side support 1004 includes a cavity 1010 defined in a side of the side support 1004 and configured to receive one of the tabs 1008. Each side support 1004 further includes one or more posts 1012 extending from a top surface thereof, and one or more holes 1014 in a bottom surface thereof. The side supports 1004 are stackable. For example, the posts 1012 of the first left side support 1004A(l) are inserted into the holes 1014 of the second left side support 1004A(2) when the left side support 1004A(2) is positioned on top of the first left side support 1004A(1).

For attaching the spool 1002(1) to the enclosure, the fixture is slid between the two side supports 1004A(1), 1004B(1) until the tabs 1008 are snapped into the cavities 1010 of the side supports 1004A(1), 1004B(1), and is maintained therein by friction, such that a slight pulling on the spool 1002(1) releases the spool 1002(1) from the side supports 1004A(1), 1004B(1). The spool 1002(1) removably engages a first left side supports 1004A(1) and a second side support 1004B(1). In particular, one tab 1008 of the first spool 1002(1) engages the cavity 1010 of the first left side support 1004A(l) and the other tab 1008 (not shown) engages the cavity 1010 of the second side support 1004B(1).

Referring to FIG. 10B, the spool stack 1000 includes a plurality of spools 1002(1)-1002(3) and a plurality of side supports 1004A(1)-1004A(3). Because the spools 1002(1) are mounted horizontally (not vertically) in the spool stack 1000, they can also be detached horizontally. Adding an additional spool 1002 simply requires adding another pair of side supports 1004B(1), 1004B(3) onto the existing stacks of side supports 1004.

Referring to FIGS. 2A, 4, 5A-7B, and 10A-10C, in certain embodiments, a plurality of spools 1002(1)-1002(3) are mounted in the interior 506 of the housing 500. At least one of the plurality of spools 1000(1)-1000(3) are configured to receive at least a portion of the first launch optical fiber 704A. The plurality of spools 1000(1)-1000(3) includes a first spool 1000(1) and a second spool 1000(2) positioned within the body 502 and attached thereto. The first spool 1000(1) is positioned between the body 502 of the housing 500 and the second spool 1000(2), and the first spool 1000(1) is configured to be detached from the housing 500 without detaching the second spool 1000(2) from the housing 500.

If, for example, the optical component attached to the second spool 1002(2) needs to be replaced, the second spool 1002(2) can be pushed out from the side supports 1004A(2), 1004B(2). When the new spool 1002 needs to be attached, it can easily be pressed to the middle location until its tabs 1008 are snapped into the cavities 1010 of the side supports 1004A(2), 1004B(2).

While the description above focuses on use of the light launch device 204 to injection signals into a traceable cable (e.g., traceable cable 206), the light launch device 204 can be used to inject signals (e.g., light) into other types of systems or apparatuses. For example, in some embodiments the light launch device 204 can be used to inject optical signals for the purpose of identifying faults in an optical connection as part of a visual fault locator (VFL).

It will be apparent to those skilled in the art that various modifications and variations can be made without departing from the spirit or scope of the invention.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

What is claimed is:

1. A light launch device, comprising:
a housing comprising a body and a cover, the body and the cover defining an interior;
at least one light source within the interior of the housing for generating an optical tracing signal; and
a launch cable assembly comprising:
an emission connector positionable within the interior of the housing; and
a launch cable comprising a launch optical fiber, the launch optical fiber comprising an input end and an emission end, the emission end located in the emission connector and the input end in optical communication with the at least one light source to receive the optical tracing signal, at least a portion of the launch cable positionable within the interior of the housing for storage and positionable external to the housing in use.

2. The light launch device of claim 1,
wherein the body of the housing defines an internal raceway; and
wherein at least a portion of the launch cable is positionable in the internal raceway.

3. The light launch device of claim 2, wherein the body further comprises a bulkhead having an optical connector receptacle, the at least one light source and the input end of the launch optical fiber are in optical communication via the optical connector receptacle of the bulkhead.

4. The light launch device of claim 3, wherein the launch cable assembly further comprises an input connector, wherein the input end of the launch optical fiber is in the input connector.

5. The light launch device of claim 4, wherein the input connector is coupleable to the optical connector receptacle of the bulkhead.

6. The light launch device of claim 3, further comprising a faceplate in the interior of the housing, wherein the faceplate is removably couplable to the body to protect the optical connector receptacle of the bulkhead.

7. The light launch device of claim 1, wherein the body further comprises a storage slot, the storage slot configured to selectively retain the emission connector.

8. The light launch device of claim 7, wherein the storage slot comprises a slot length and the emission connector comprises a connector length, wherein the slot length is at least twice the connector length.

9. The light launch device of claim 1, wherein the cover or the body defines a passage for receiving at least a portion of the launch cable therein to allow for positioning the emission connector external to the housing when the cover is in a closed position.

10. The light launch device of claim 1, further comprising a plurality of spools positioned in the interior of the housing, at least one of the plurality of spools configured to receive at least a portion of the launch optical fiber, the plurality of spools comprising a first spool and a second spool attached to the housing, the first spool positioned between the body of the housing and the second spool, and the first spool configured to be detachable from the housing without detaching the second spool from the housing.

11. A light launch device, comprising:
a housing comprising a body, a cover, and bulkhead on the body, the bulkhead comprising an optical connector receptacle,
at least one light source for generating an optical tracing signal, the at least one light source in optical communication with the optical connector receptacle of the bulkhead; and
a launch cable assembly comprising a launch cable, an input connector at a first end of the launch cable, and an emission connector at a second end of the launch cable, wherein the input connector is couplable to the optical connector receptacle of the bulkhead, wherein at least a portion of the launch cable is positionable within the housing for storage and positionable external to the housing in use.

12. The light launch device of claim 11,
wherein the housing further comprises an internal raceway; and
wherein at least a portion of the launch cable is positionable in the internal raceway.

13. The light launch device of claim 11, further comprising a faceplate attacheable to the body, wherein the faceplate comprises at least one aperture providing access through the faceplate to at least one operational component of the body.

14. The light launch device of claim 13, wherein the at least one operational component comprises a power button and at least one light indicator.

15. The light launch device of claim 11, wherein the at least one light source comprises a first light source for generating a first optical tracing signal and a second light source for generating a second optical tracing signal.

16. The light launch device of claim 15, wherein the first light source is configured to emit the first optical tracing signal in each instance of a repeating cycle and the second light source is configured to emit the second tracing optical signal in each instance of the repeating cycle, wherein the repeating cycle comprises a cycle duration.

17. The light launch device of claim 16, wherein the first light source emits the first optical tracing signal for about 25%-35% of the cycle duration.

18. The light launch device of claim 16, wherein the second light source emits the second optical tracing signal for about 25%-35% of the cycle duration.

19. A light launch device for a traceable fiber optic cable assembly, comprising:
a housing;
at least one light source within the housing for generating a first optical tracing signal and a second optical tracing signal; and
a launch cable assembly comprising:
an input connector configured to receive the first and second optical tracing signals from the at least one light source;
an emission connector configured to engage a traceable fiber optic cable assembly;
a first launch optical fiber comprising a first input end and a first emission end, the first input end in communication with the at least one light source to receive the first optical tracing signal and the first emission end located in the emission connector; and
a second launch optical fiber comprising a second input end and a second emission end, the second input end in communication with the at least one light source to receive the second optical tracing signal and the second emission end located in the emission connector;
wherein the at least one light source is configured to alternate emission of the first optical tracing signal and the second optical tracing signal.

20. The light launch device of claim 19, further comprising at least two mandrels within the housing, the first launch optical fiber positioned in a figure eight configuration around the at least two mandrels.

21. The light launch device of claim 19, wherein the first optical tracing signal comprises a green laser signal.

22. The light launch device of claim 19, wherein the at least one light source is configured to emit the first optical tracing signal and the second tracing optical signal in each instance of a repeating cycle and wherein the repeating cycle comprises a cycle duration.

23. The light launch device of claim 22, wherein the at least one light source emits the first optical tracing signal for about 25%-35% of the cycle duration.

24. The light launch device of claim 22, wherein the at least one light source emits the second optical tracing signal for about 25%-35% of the cycle duration.
